(19) United States
(12) Patent Application Publication
(10) Pub. No.: US 2019/0310737 A1
(43) Pub. Date: Oct. 10, 2019

(54) ELECTRONIC DEVICE AND ELECTRONIC DEVICE OPERATING METHOD

(71) Applicant: Samsung Electronics Co., Ltd., Gyeonggi-do (KR)

(72) Inventors: Jeongsik JEONG, Gyeonggi-do (KR); Hanvit KANG, Gyeonggi-do (KR); Hokyung KANG, Daegu (KR); Byeongcheol KIM, Gyeonggi-do (KR); Jungwon KIM, Gyeonggi-do (KR); Kyungwan PARK, Gyeonggi-do (KR); Kwangtai KIM, Gyeonggi-do (KR); Hyungsup BYEON, Gyeonggi-do (KR); Hyunju HONG, Gyeonggi-do (KR)

(21) Appl. No.: 16/314,888

(22) PCT Filed: May 30, 2017
(86) PCT No.: PCT/KR2017/005630

§ 371 Date: Jan. 3, 2019

(30) Foreign Application Priority Data
Jul. 12, 2016 (KR) 10-2016-0088255

(51) Int. Cl. G06F 3/041; G06F 3/0354; G06F 3/038; G06F 3/0488; G06F 3/044

(52) U.S. Cl. CPC G06F 3/0418; G06F 3/03545; G06F 3/038; G06F 2203/04106; G06F 3/04886; G06F 3/0445; G06F 3/04883

(57) ABSTRACT

Electronic devices and electronic device operating methods according to various embodiments may comprise: a housing; a display; a touch sensor; a pen sensor; a pressure sensor; and a processor. The processor: senses the pressure of an external object on the display using the pressure sensor; senses a touch position of the external object using the touch sensor when the external object includes a conductor; senses the touch position of the external object using the pen sensor when the external object is a stylus pen configured to be capable of transmitting an electromagnetic signal to the pen sensor; senses the touch position of the external object using the pressure sensor when the external object cannot be sensed by the touch sensor and/or the pen sensor; and can perform at least one function on the basis of at least in part the touch position sensed by the touch sensor, the pen sensor and/or the pressure sensor, and the pressure sensed by the pressure sensor.

### TECHNICAL FIELD

Various embodiments of the present invention relate to an electronic device and an operating method thereof. Particularly, embodiments of the present invention relate to technique to sense a position and pressure corresponding to a touch input of an external object on a display by using sensors in the electronic device.

### BACKGROUND ART

Processors equipped in various electronic devices such as a smart phone, a tablet PC, a portable multimedia player (PMP), a personal digital assistant (PDA), a laptop personal computer (PC), and a wearable device are being developed.

Such an electronic device further includes a touch panel having a touch sensor in a display to sense an input of a user of the electronic device on the display. This performs a function of input mechanism for receiving user manipulations.

### DISCLOSURE OF INVENTION

### Technical Problem

A touch sensor equipped in an electronic device can sense a touch position on a display, based on a change in capacitance formed inside the touch sensor by a touch of an external object having conductivity. However, when an external object having insulation is touched on the display, no change in capacitance formed inside the touch sensor occurs, so that the touch position on the display cannot be detected.

Furthermore, when a conductive liquid (e.g., tap water, seawater, or the like) exists on a surface of the display, a malfunction of the touch sensor occurs due to the conductive liquid. Therefore, the touch sensor fails to accurately detect the touch position on the display.

Various embodiments of the present invention is to solve the above-described problems and provide an electronic device and an operation method thereof for accurately sensing a touch position of an external object by using at least one sensor equipped in the electronic device.

### Solution to Problem

According to an embodiment of the present invention, an electronic device may comprise a housing including a first surface facing a first direction and a second surface facing a second direction opposite to the first direction; a display disposed between the first and second surfaces of the housing and exposed through the first surface; a touch sensor disposed between the first surface of the housing and the display or within the display, and configured to sense a position on the display, the touch being performed by an external object; a pen sensor disposed between the display and the second surface of the housing, and configured to sense a touch position of a stylus pen on the display; a pressure sensor disposed between the pen sensor and the second surface of the housing, and configured to sense a pressure of the external object on the display; at least one processor electrically connected to the display, the touch sensor, the pen sensor, and the pressure sensor; and at least one memory electrically connected to the at least one processor, wherein the at least one memory stores instructions causing the at least one processor to: sense a pressure of the external object with respect to the display by using the pressure sensor, sense a touch position of the external object by using the touch sensor when the external object includes a conductor, sense the touch position of the external object by using the pen sensor when the external object is a stylus pen configured to be capable of transmitting an electromagnetic signal to the pen sensor, sense the touch position of the external object by using the pressure sensor in case of failing to sense the external object through the touch sensor and/or the pen sensor, and perform at least one function, based on, at least in part, the touch position sensed by the touch sensor, the pen sensor, and/or the pressure sensor, and the pressure sensed by the pressure sensor.

According to another embodiment of the present invention, an electronic device may comprise a housing including a first surface facing a first direction and a second surface facing a second direction opposite to the first direction; a display disposed between the first and second surfaces of the housing and exposed through the first surface; a first sensor disposed between the first and second surfaces of the housing, and configured to sense a touch position of an external object with respect to the display at a first resolution and thereby generate first coordinate data; a second sensor disposed between the first and second surfaces of the housing, and configured to sense the touch position at a second resolution, perform a sensing in a different manner of the first sensor, and thereby generate second coordinate data; a third sensor disposed between the first and second surfaces of the housing, and configured to sense at a third resolution the touch position and pressure data applied to the display by the external object and thereby generate third coordinate data; at least one processor electrically connected to the display, the first sensor, the second sensor, and the third sensor; and at least one memory electrically connected to the at least one processor, wherein the at least one memory stores instructions causing the at least one processor to: when the external object is in contact with the display, perform a first operation based on, at least in part, the first coordinate data, when the first coordinate data and the third coordinate data are received from the first sensor and the third sensor, respectively, and when the second coordinate data is not received from the second sensor, perform the first operation based on, at least in part, the second coordinate data, when the second coordinate data and the third coordinate data are received from the second sensor and the third sensor, respectively, and when the first coordinate data is not received from the first sensor, and perform the first operation based on, at least in part, the third coordinate data, when the third coordinate data is received from the third sensor, and when the first coordinate data and the second coordinate data are not received from the first sensor and the second sensor, respectively.

According to various embodiments of the present invention, a method of operating an electronic device including a first sensor, a second sensor, and a third sensor receiving a touch position of an external object with respect to a display at a first resolution, a second resolution, and a third resolution may comprise sensing a touch of the external object with respect to the display; performing a first operation based on, at least in part, first coordinate data, when the first coordinate data and third coordinate data are received from the first sensor and the third sensor, respectively, and when second coordinate data is not received from the second sensor; performing the first operation based on, at least in part, the second coordinate data, when the second coordinate data and the third coordinate data are received, and when the first coordinate data is not received; and performing the first operation based on, at least in part, the third coordinate data, when the third coordinate data is received, and when the first coordinate data and the second coordinate data are not received.

In a computer recording medium storing computer-readable instructions according to an embodiment disclosed herein, the instructions may comprise operations of, in response to a touch input of an external object with respect to the display, performing a first operation based on, at least in part, first coordinate data, when the first coordinate data and third coordinate data are received from the first sensor and the third sensor, respectively, and when second coordinate data is not received from the second sensor; performing the first operation based on, at least in part, the second coordinate data, when the second coordinate data and the third coordinate data are received, and when the first coordinate data is not received; and performing the first operation based on, at least in part, the third coordinate data, when the third coordinate data is received, and when the first coordinate data and the second coordinate data are not received.

### Advantageous Effects of Invention

An electronic device and an operation method thereof according to various embodiments of the present invention can accurately sense a touch input of an external object with respect to a display by using a pen sensor and/or a pressure sensor when a touch sensor fails to sense the touch input.

An electronic device and an operation method thereof according to various embodiments of the present invention can accurately sense, by using a separate sensor, a touch input to a display from an external object having insulation when the touch sensor is incapable of sensing the touch input.

### BRIEF DESCRIPTION OF DRAWINGS

FIG. 1 illustrates an electronic device in a network environment according to various embodiments of the present invention.

FIG. 2 is a block diagram of an electronic device according to various embodiments of the present invention.

FIG. 3 is a block diagram of a program module according to various embodiments of the present invention.

FIGS. 4A to 4D are diagrams illustrating the structure of an electronic device according to an embodiment of the present invention.

FIGS. 5A and 5B are diagrams illustrating the structure of an electronic device according to another embodiment of the present invention.

FIGS. 6A to 6D are diagrams illustrating the operation of an electronic device according to an embodiment of the present invention.

FIG. 7 is a flow diagram illustrating an operating method of an electronic device according to an embodiment of the present invention.

FIG. 8 is a flow diagram illustrating an operating method of an electronic device according to another embodiment of the present invention.

FIG. 9 is a flow diagram illustrating an operating method of an electronic device according to still another embodiment of the present invention.

FIG. 10 is a flow diagram illustrating an operating method of an electronic device according to yet another embodiment of the present invention.

FIG. 11 is a diagram illustrating the structure of an electronic device according to still another embodiment of the present invention.

### MODE FOR THE INVENTION

The following description is made with reference to the accompanying drawings and is provided to assist in a comprehensive understanding of various example embodiments of the present disclosure as defined by the claims and their equivalents. It includes various specific details to assist in that understanding but these are to be regarded as merely examples. Accordingly, those of ordinary skill in the art will recognize that various changes and modifications of the various example embodiments described herein can be made without departing from the scope and spirit of the present disclosure. In addition, descriptions of well-known functions and constructions may be omitted for clarity and conciseness. The terms and words used in the following description and claims are not limited to the bibliographical meanings, but, may simply be used to enable a clear and consistent understanding of the present disclosure. Accordingly, it should be apparent to those skilled in the art that the following description of various example embodiments of the present disclosure is provided for illustration purpose only and not for the purpose of limiting the present disclosure as defined by the appended claims and their equivalents. It is to be understood that the singular forms “a,” “an,” and “the” include plural referents unless the context clearly dictates otherwise. Thus, for example, reference to “a component surface” includes reference to one or more of such surfaces. The term “substantially” may generally denote that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide. The expressions, such as “include” and “may include” which may be used in the present disclosure may refer, for example, to the presence of the disclosed functions, operations, and constituent elements and do not limit one or more additional functions, operations, and elements. In an example embodiment of the present disclosure, the terms, such as “include” and/or “have” may be understood to refer, for example, to a certain characteristic, number, operation, constituent element, component or a combination thereof, but may not be construed to exclude the existence of or a possibility of addition of one or more other characteristics, numbers, operations, constituent elements, components or combinations thereof. Furthermore, in the present disclosure, the expression “and/or” includes any and all combinations of the associated listed words. For example, the expression “A and/or B” may include A, may include B, or may include both A and B. In an example embodiment of the present disclosure, expressions including ordinal numbers, such as “first” and “second,” and the like, may modify various elements. However, such elements are not limited by the above expressions. For example, the above expressions do not limit the sequence and/or importance of the elements.

The above expressions are used merely for the purpose to distinguish an element from the other elements. For example, a first user device and a second user device indicate different user devices although both of them are user devices. For example, a first element could be termed a second element, and similarly, a second element could be also termed a first element without departing from the scope of the present disclosure.

In the case where a component is referred to as being “connected” or “accessed” to other component, it should be understood that not only the component is directly connected or accessed to the other component, but also there may exist another component between them. Meanwhile, in the case where a component is referred to as being “directly connected” or “directly accessed” to other component, it should be understood that there is no component therebetween.

An electronic device according to the present disclosure may be a device including a communication function. For example, and without limitation, the device may correspond to a combination of at least one of a smartphone, a tablet personal computer (PC), a mobile phone, a video phone, an e-book reader, a desktop PC, a laptop PC, a netbook computer, a personal digital assistant (PDA), a portable multimedia player (PMP), a digital audio player, a mobile medical device, an electronic bracelet, an electronic necklace, an electronic accessory, a camera, a wearable device, an electronic clock, a wrist watch, home appliances (for example, an air-conditioner, vacuum, an oven, a microwave, a washing machine, an air cleaner, and the like), an artificial intelligence robot, a television (TV), a digital versatile disc (DVD) player, an audio device, various medical devices (for example, magnetic resonance angiography (MRA), magnetic resonance imaging (MRI), computed tomography (CT), a scanning machine, a ultrasonic wave device, and the like), a navigation device, a global positioning system (GPS) receiver, an event data recorder (EDR), a flight data recorder (FDR), a set-top box, a TV box (for example, Samsung HomeSync™, Apple TV™, or Google TV™), an electronic dictionary, vehicle infotainment device, an electronic equipment for a ship (for example, navigation equipment for a ship, gyrocompass, and the like), avionics, a security device, electronic clothes, an electronic key, a camcorder, game consoles, a head-mounted display (HMD), a flat panel display device, an electronic frame, an electronic album, furniture or a portion of a building/structure that includes a communication function, an electronic board, an electronic signature receiving device, a projector, or the like. It will be apparent to those skilled in the art that the electronic device according to the present disclosure is not limited to the aforementioned devices.

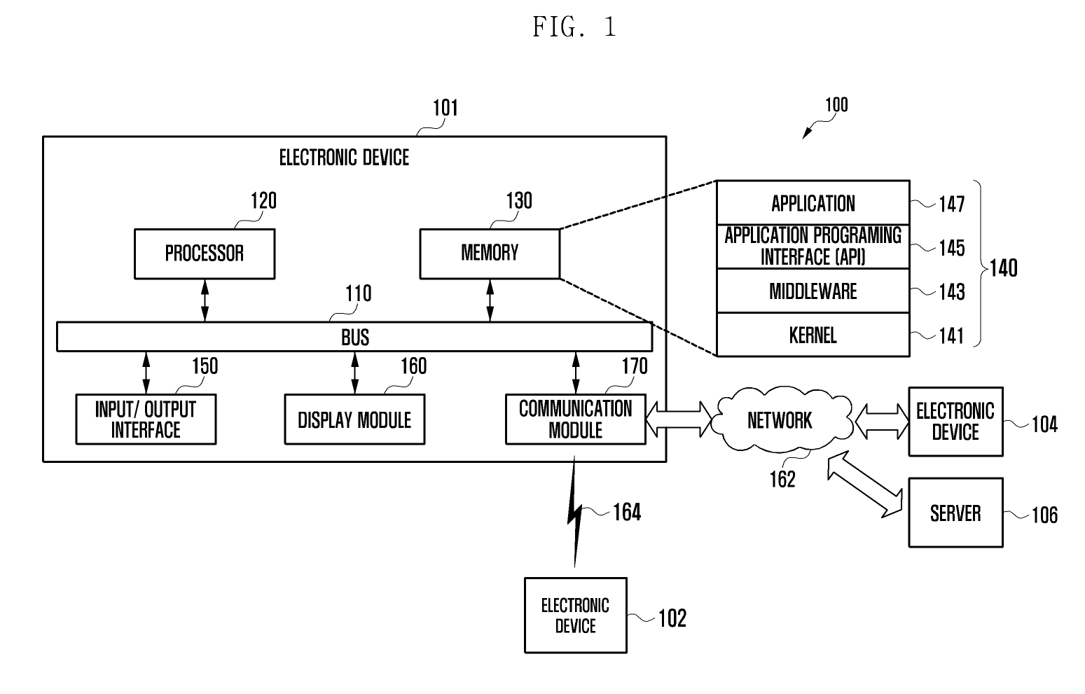

FIG. 1 is a block diagram illustrating example electronic devices in a network environment 100 according to various example embodiments of the present disclosure. Referring to FIG. 1, an electronic device 101 may include a bus 110, a processor (e.g., including processing circuitry) 120, a memory 130, an input/output interface (e.g., including interface circuitry) 150, a display 160, a communication interface (e.g., including communication circuitry) 170, and other similar and/or suitable components. The bus 110 may be a circuit which interconnects the above-described elements and delivers a communication (e.g., a control message) between the above-described elements. The processor 120 may include various processing circuitry and receive commands from the above-described other elements (e.g., the memory 130, the input/output interface 150, the display 160, the communication 170, and the like) through the bus 110, may interpret the received commands, and may execute calculation or data processing according to the interpreted commands. Although illustrated as one element, the processor 120 may include multiple processors without departing from the teachings herein.

The memory 130 may store commands or data received from the processor 120 or other elements (e.g., the input/output interface 150, the display 160, the communication interface 170, and the like) or generated by the processor 120 or the other elements.

The memory 130 may include programming modules 140, such as a kernel 141, middleware 143, an application programming interface (API) 145, an application 147, and the like. Each of the above-described programming modules may be implemented in software, firmware, hardware, or a combination of two or more thereof. The kernel 141 may control or manage system resources (e.g., the bus 110, the processor 120, the memory 130, and the like) used to execute operations or functions implemented by other programming modules (e.g., the middleware 143, the API 145, and the application 147). In addition, the kernel 141 may provide an interface capable of accessing and controlling or managing the individual elements of the electronic device 100 by using the middleware 143, the API 145, or the application 147. The middleware 143 may serve to go between the API 145 or the application 147 and the kernel 141 in such a manner that the API 145 or the application 147 communicates with the kernel 141 and exchanges data therewith. In addition, in relation to work requests received from one or more applications 140 and/or the middleware 143, for example, may perform load balancing of the work requests by using a method of assigning a priority, in which system resources (e.g., the bus 110, the processor 120, the memory 130, and the like) of the electronic device 100 can be used, to at least one of the one or more applications 140. The API 145 is an interface through which the application 147 is capable of controlling a function provided by the kernel 141 or the middleware 143, and may include, for example, at least one interface or function for file control, window control, image processing, character control, and the like.

The input/output interface 150 may include various interface circuitry and, for example, may receive a command or data as input from a user, and may deliver the received command or data to the processor 120 or the memory 130 through the bus 110. The display 160 may display a video, an image, data, and the like, to the user.

The communication interface 170 may include various communication circuitry and connect communication between electronic devices 102 and 104 and the electronic device 100. The communication interface 170 may support a short-range communication protocol 164 (e.g., Wi-Fi, Bluetooth (BT), and near field communication (NFC)), or a network communication 162 (e.g., the internet, a local area network (LAN), a wide area network (WAN), a telecommunication network, a cellular network, a satellite network, a plain old telephone service (POTS), and the like).

Each of the electronic devices 102 and 104 may be a device which is identical (e.g., of an identical type) to or different (e.g., of a different type) from the electronic device 100. Further, the communication interface 170 may connect communication between a server 106 and the electronic device 100 via the network 162.

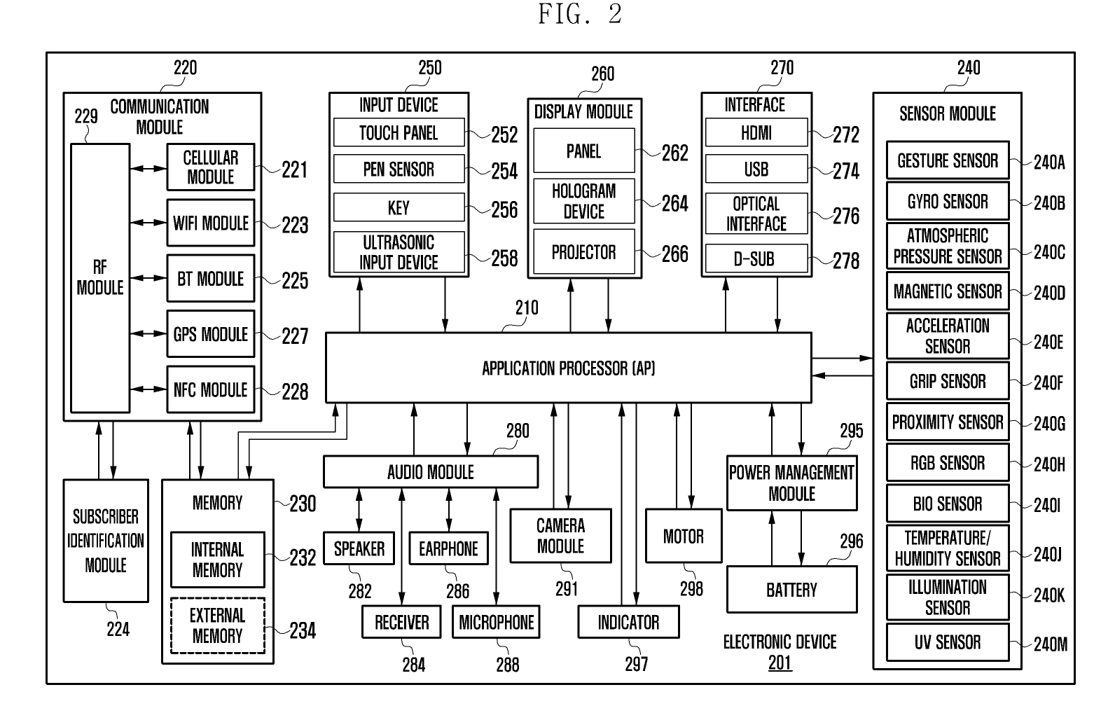

FIG. 2 is a block diagram illustrating an example electronic device according to various example embodiments of the present disclosure. Referring to FIG. 2, an electronic device 201 may be, for example, the electronic device 101 illustrated in FIG. 1. Referring to FIG. 2, the electronic device 201 may include a processor (e.g., and application processor including processing circuitry) 210, a subscriber identification module (SIM) card 224, a memory 230, a communication module (e.g., including communication circuitry) 220, a sensor module 240, an input device (e.g., including input circuitry) 250, a display 260, an interface (e.g., including interface circuitry) 270, an audio module (coder/decoder (codec)) 280, a camera module 291, a power management module 295, a battery 296, an indicator 297, a motor 298 and any other similar and/or suitable components. The processor 210 may include various processing circuitry, such as, for example, and without limitation, one or more of a dedicated processor, a CPU, application processors (APs) (not illustrated), or one or more communication processors (CPs) (not illustrated). The processor 210 may be, for example, the processor 120 illustrated in FIG. 1. The AP and the CP may be included in the processor 210 in FIG. 2, or may be included in different integrated circuit (IC) packages, respectively. According to an embodiment of the present disclosure, the AP and the CP may be included in one IC package. The AP may execute an operating system (OS) or an application program, and thereby may control multiple hardware or software elements connected to the AP and may perform processing of and arithmetic operations on various data including multimedia data. The AP may be implemented by, for example, a system on chip (SoC). According to an embodiment of the present disclosure, the processor 210 may further include a graphical processing unit (GPU) (not illustrated).

The CP may manage a data line and may convert a communication protocol in the case of communication between the electronic device (e.g., the electronic device 100) including the electronic device 201 and different electronic devices connected to the electronic device through the network. The CP may be implemented by, for example, an SoC. According to an embodiment of the present disclosure, the CP may perform at least some of multimedia control functions. The CP, for example, may distinguish and authenticate a terminal in a communication network by using a SIM (e.g., the SIM card 224). In addition, the CP may provide the user with services, such as a voice telephony call, a video telephony call, a text message, packet data, and the like. Further, the CP may control the transmission and reception of data by the communication module 220. In FIG. 2, the elements, such as the power management module 295, the memory 230, and the like are illustrated as elements separate from the processor 210. However, according to an embodiment of the present disclosure, the processor 210 may include at least some of the above-described elements (e.g., the power management module 295). According to an example embodiment of the present disclosure, the AP or the CP may load, to a volatile memory, a command or data received from at least one of a non-volatile memory and other elements connected to each of the AP and the CP, and may process the loaded command or data. In addition, the AP or the CP may store, in a non-volatile memory, data received from or generated by at least one of the other elements. The SIM card 224 may be a card implementing a SIM, and may be inserted into a slot formed in a particular portion of the electronic device 201. The SIM card 224 may include unique identification information (e.g., IC card identifier (ICCID)) or subscriber information (e.g., international mobile subscriber identity (IMSI)).

The memory 230 may include an internal memory 232 and/or an external memory 234. The memory 230 may be, for example, the memory 130 illustrated in FIG. 1. The internal memory 232 may include, for example, at least one of a volatile memory (e.g., a dynamic random access memory (DRAM), a static RAM (SRAM), a synchronous dynamic RAM (SDRAM), and the like), and a non-volatile memory (e.g., a one time programmable read only memory (OTPROM), a programmable ROM (PROM), an erasable and programmable ROM (EPROM), an electrically erasable and programmable ROM (EEPROM), a mask ROM, a flash ROM, a not AND (NAND) flash memory, a not OR (NOR) flash memory, and the like). According to an embodiment of the present disclosure, the internal memory 232 may be in the form of a solid state drive (SSD). The external memory 234 may further include a flash drive, for example, a compact flash (CF), a secure digital (SD), a micro-SD, a mini-SD, an extreme digital (xD), a memory stick, and the like.

The communication module 220 may include various communication circuitry including, for example, and without limitation, a radio frequency (RF) module 229. The communication module 220 may be, for example, the communication interface 170 illustrated in FIG. 1. The communication module 220 may further include various communication circuitry including, for example, and without limitation, wireless communication modules to enable wireless communication through the RF module 229. The wireless communication modules may include, for example, and without limitation, a cellular module 221, a Wi-Fi module 223, a BT module 225, a GPS module 227, and/or a NFC module 228. Additionally or alternatively, the wireless communication modules may further include a network interface (e.g., a LAN card), a modulator/demodulator (modem), and the like for connecting the electronic device 201 to a network (e.g., the internet, a LAN, a WAN, a telecommunication network, a cellular network, a satellite network, a POTS, and the like) (not illustrated).The communication module 220 (e.g., the communication interface 170) may perform data communication with other electronic devices (e.g., the electronic devices 102 and 104, and the server 106) through a network (e.g., network 162). The RF module 229 may be used for transmission and reception of data, for example, transmission and reception of RF signals or called electronic signals. Although not illustrated, the RF unit 229 may include, for example, a transceiver, a power amplifier module (PAM), a frequency filter, a low noise amplifier (LNA), and the like. In addition, the RF module 229 may further include a component for transmitting and receiving electromagnetic waves in a free space in a wireless communication, for example, a conductor, a conductive wire, and the like. The sensor module 240 may include, for example, at least one of a gesture sensor 240A, a gyro sensor 240B, an atmospheric pressure (e.g., barometer) sensor 240C, a magnetic sensor 240D, an acceleration sensor 240E, a grip sensor 240F, a proximity sensor 240G, a red, green and blue (RGB) sensor 240H, a biometric sensor 2401, a temperature/humidity sensor 240J, an illuminance (e.g., light) sensor 240K, and an ultra violet (UV) sensor 240M. The sensor module 240 may measure a physical quantity or may detect an operating state of the electronic device 201, and may convert the measured or detected information to an electrical signal. Additionally/alternatively, the sensor module 240 may include, for example, an electronic nose (E-nose) sensor (not illustrated), an electromyography (EMG) sensor (not illustrated), an electroencephalogram (EEG) sensor (not illustrated), an electrocardiogram (ECG) sensor (not illustrated), a fingerprint sensor (not illustrated), and the like. Additionally or alternatively, the sensor module 240 may include, for example, an E-nose sensor (not illustrated), an EMG sensor (not illustrated), an EEG sensor (not illustrated), an ECG sensor (not illustrated), a fingerprint sensor, and the like. The sensor module 240 may further include a control circuit (not illustrated) for controlling one or more sensors included therein. The sensor module 240 may also, or in the alternative, be controlled by the processor 210. The input device 250 may include various input circuitry, such as, for example, and without limitation, a touch panel 252, a pen sensor 254 (e.g., a digital pen sensor), keys 256, and an ultrasonic input device 258. The input device 250 may be, for example, the input/output interface 150 illustrated in FIG. 1. The touch panel 252 may recognize a touch input in at least one of, for example, a capacitive scheme, a resistive scheme, an infrared scheme, and an acoustic wave scheme. In addition, the touch panel 252 may further include a controller (not illustrated). In the capacitive type, the touch panel 252 is capable of recognizing proximity as well as a direct touch. The touch panel 252 may further include a tactile layer (not illustrated). In this event, the touch panel 252 may provide a tactile response to the user.

The pen sensor 254 (e.g., a digital pen sensor), for example, may be implemented by using a method identical or similar to a method of receiving a touch input from the user, or by using a separate sheet for recognition. For example, a key pad or a touch key may be used as the keys 256. The ultrasonic input device 258 enables the terminal to detect a sound wave by using a microphone (e.g., a microphone 288) of the terminal through a pen generating an ultrasonic signal, and to identify data. The ultrasonic input device 258 is capable of wireless recognition. According to an embodiment of the present disclosure, the electronic device 201 may receive a user input from an external device (e.g., a network, a computer, or a server), which is connected to the electronic device 201, through the communication module 220. The display 260 may include a panel 262, a hologram 264, and a projector 266. The display 260 may be, for example, the display 160 illustrated in FIG. 1. The panel 262 may be, for example, a liquid crystal display (LCD) and an active matrix organic light emitting diode (AM-OLED) display, or the like, but is not limited thereto. The panel 262 may be implemented so as to be, for example, flexible, transparent, or wearable. The panel 262 may include the touch panel 252 and one module. The hologram 264 may display a three-dimensional image in the air by using interference of light. The projector 266 may include light-projecting elements, such as LEDs, to project light into external surfaces. According to an embodiment of the present disclosure, the display 260 may further include a control circuit for controlling the panel 262, the hologram 264, or the projector 266. The interface 270 may include various interface circuitry, such as, for example, and without limitation, a high-definition multimedia interface (HDMI) 272, a universal serial bus (USB) 274, an optical interface 276, and a d-subminiature (D-sub) 278. Additionally or alternatively, the interface 270 may include, for example, SD/multi-media card (MMC) (not illustrated) or infrared data association (IrDA) (not illustrated).

The audio module (codec) 280 may bidirectionally convert between a voice and an electrical signal. The audio module 280 may convert voice information, which is input to or output from the audio module 280, through, for example, a speaker 282, a receiver 284, an earphone 286, the microphone 288, and the like. The camera module 291 may capture an image and a moving image. According to an embodiment of the present disclosure, the camera module 291 may include one or more image sensors (e.g., a front lens or a back lens), an image signal processor (ISP) (not illustrated), and a flash LED (not illustrated).

The power management module 295 may manage power of the electronic device 201. Although not illustrated, the power management module 295 may include, for example, a power management IC (PMIC), a charger IC, or a battery fuel gauge. The PMIC may be mounted to, for example, an IC or an SoC semiconductor. Charging methods may be classified into a wired charging method and a wireless charging method. The charger IC may charge a battery, and may prevent an overvoltage or an overcurrent from a charger to the battery. According to an embodiment of the present disclosure, the charger IC may include a charger IC for at least one of the wired charging method and the wireless charging method. Examples of the wireless charging method may include a magnetic resonance method, a magnetic induction method, an electromagnetic method, and the like. Additional circuits (e.g., a coil loop, a resonance circuit, a rectifier, and the like) for wireless charging may be added in order to perform the wireless charging. The battery fuel gauge may measure, for example, a residual quantity of the battery 296, or a voltage, a current or a temperature during the charging. The battery 296 may supply power by generating electricity, and may be, for example, a rechargeable battery.

The indicator 297 may indicate particular states of the electronic device 201 or a part of the electronic device 201 (e.g., the AP), for example, a booting state, a message state, a charging state and the like. The motor 298 may convert an electrical signal into a mechanical vibration.

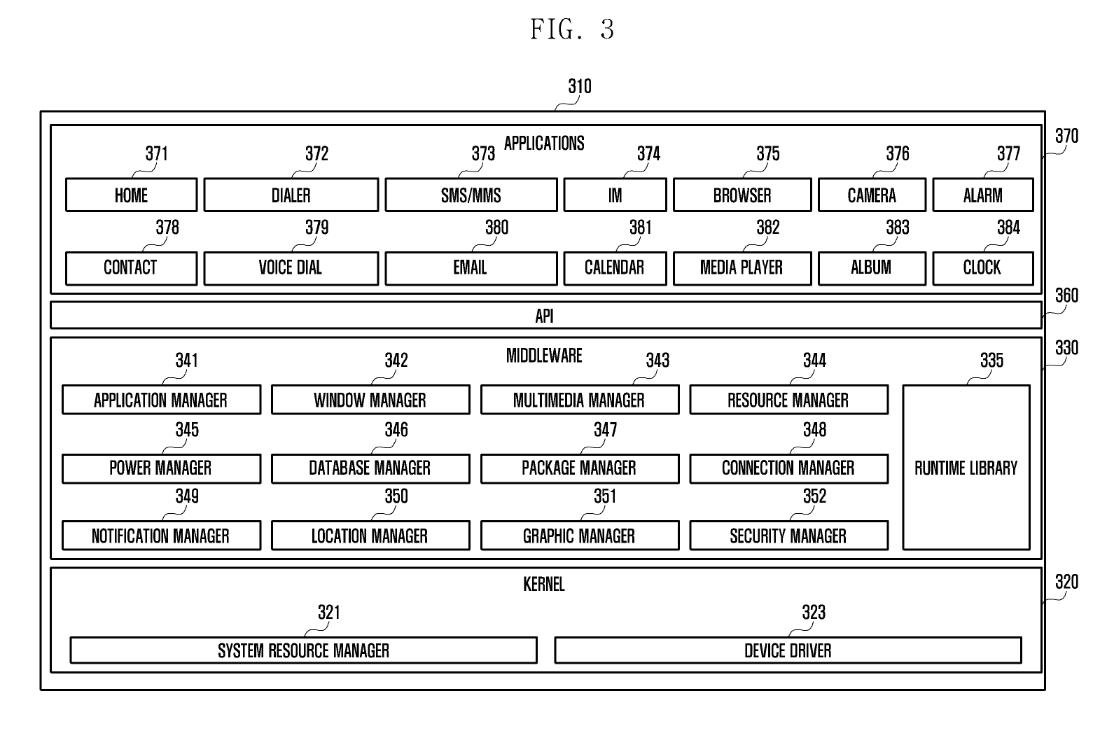

FIG. 3 is a block diagram illustrating an example configuration of a programming module according to an example embodiment of the present disclosure. Referring to FIG. 3, a programming module 300 may be included (or stored) in the electronic device 100 (e.g., the memory 130) or may be included (or stored) in the electronic device 201 (e.g., the memory 230) illustrated in FIG. 1. At least a part of the programming module 300 may be implemented in software, firmware, hardware, or a combination of two or more thereof. The programming module 300 may be implemented in hardware (e.g., the electronic device 201), and may include an OS controlling resources related to an electronic device (e.g., the electronic device 100) and/or various applications (e.g., an application 370) executed in the OS. For example, the OS may be Android, iOS, Windows, Symbian, Tizen, Bada, and the like. Referring to FIG. 3, the programming module 300 may include a kernel 320, a middleware 330, an API 360, and/or the application 370. The kernel 320 (e.g., the kernel 141) may include a system resource manager 321 and/or a device driver 323. The system resource manager 321 may include, for example, a process manager (not illustrated), a memory manager (not illustrated), and a file system manager (not illustrated). The system resource manager 321 may perform the control, allocation, recovery, and the like of system resources. The device driver 323 may include, for example, a display driver (not illustrated), a camera driver (not illustrated), a BT driver (not illustrated), a shared memory driver (not illustrated), a USB driver (not illustrated), a keypad driver (not illustrated), a Wi-Fi driver (not illustrated), and/or an audio driver (not illustrated). In addition, according to an embodiment of the present disclosure, the device driver 323 may include an inter-process communication (IPC) driver (not illustrated).

The middleware 330 may include multiple modules previously implemented so as to provide a function used in common by the applications 370. In addition, the middleware 330 may provide a function to the applications 370 through the API 360 in order to enable the applications 370 to efficiently use limited system resources within the electronic device. For example, as illustrated in FIG. 3, the middleware 330 (e.g., the middleware 143) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352, and any other suitable and/or similar manager. The runtime library 335 may include, for example, a library module used by a complier, in order to add a new function by using a programming language during the execution of the application 370. According to an embodiment of the present disclosure, the runtime library 335 may perform functions which are related to input and output, the management of a memory, an arithmetic function, and the like.

The application manager 341 may manage, for example, a life cycle of at least one of the applications 370. The window manager 342 may manage graphical user interface (GUI) resources used on the screen. The multimedia manager 343 may detect a format used to reproduce various media files and may encode or decode a media file through a codec appropriate for the relevant format. The resource manager 344 may manage resources, such as a source code, a memory, a storage space, and the like of at least one of the applications 370. The power manager 345 may operate together with a basic input/output system (BIOS), may manage a battery or power, and may provide power information and the like used for an operation. The database manager 346 may manage a database in such a manner as to enable the generation, search and/or change of the database to be used by at least one of the applications 370. The package manager 347 may manage the installation and/or update of an application distributed in the form of a package file.

The connectivity manager 348 may manage a wireless connectivity, such as, for example, Wi-Fi and BT. The notification manager 349 may display or report, to the user, an event, such as an arrival message, an appointment, a proximity alarm, and the like in such a manner as not to disturb the user. The location manager 350 may manage location information of the electronic device. The graphic manager 351 may manage a graphic effect, which is to be provided to the user, and/or a user interface related to the graphic effect. The security manager 352 may provide various security functions used for system security, user authentication, and the like. According to an embodiment of the present disclosure, when the electronic device (e.g., the electronic device 100) has a telephone function, the middleware 330 may further include a telephony manager (not illustrated) for managing a voice telephony call function and/or a video telephony call function of the electronic device.

The middleware 330 may generate and use a new middleware module through various functional combinations of the above-described internal element modules. The middleware 330 may provide modules specialized according to types of OSs in order to provide differentiated functions. In addition, the middleware 330 may dynamically delete some of the existing elements, or may add new elements. Accordingly, the middleware 330 may omit some of the elements described in the various embodiments of the present disclosure, may further include other elements, or may replace the some of the elements with elements, each of which performs a similar function and has a different name. The API 360 (e.g., the API 145) is a set of API programming functions, and may be provided with a different configuration according to an OS. In the case of Android or iOS, for example, one API set may be provided to each platform. In the case of Tizen, for example, two or more API sets may be provided to each platform. The applications 370 (e.g., the applications 147) may include, for example, a preloaded application and/or a third party application. The applications 370 may include, for example, a home application 371, a dialer application 372, a short message service (SMS)/multimedia message service (MMS) application 373, an instant message (IM) application 374, a browser application 375, a camera application 376, an alarm application 377, a contact application 378, a voice dial application 379, an electronic mail (e-mail) application 380, a calendar application 381, a media player application 382, an album application 383, a clock application 384, and any other suitable and/or similar application. At least a part of the programming module 300 may be implemented by instructions stored in a non-transitory computer-readable storage medium. When the instructions are executed by one or more processors (e.g., the processor 210), the one or more processors may perform functions corresponding to the instructions. The non-transitory computer-readable storage medium may be, for example, the memory 230. At least a part of the programming module 300 may be implemented (e.g., executed) by, for example, the processor 210. At least a part of the programming module 300 may include, for example, a module, a program, a routine, a set of instructions, and/or a process for performing one or more functions. Names of the elements of the programming module (e.g., the programming module 300) according to an embodiment of the present disclosure may change depending on the type of OS. The programming module according to an embodiment of the present disclosure may include one or more of the above-described elements. Alternatively, some of the above-described elements may be omitted from the programming module. Alternatively, the programming module may further include additional elements. The operations performed by the programming module or other elements according to an embodiment of the present disclosure may be processed in a sequential method, a parallel method, a repetitive method, or a heuristic method. In addition, some of the operations may be omitted, or other operations may be added to the operations.

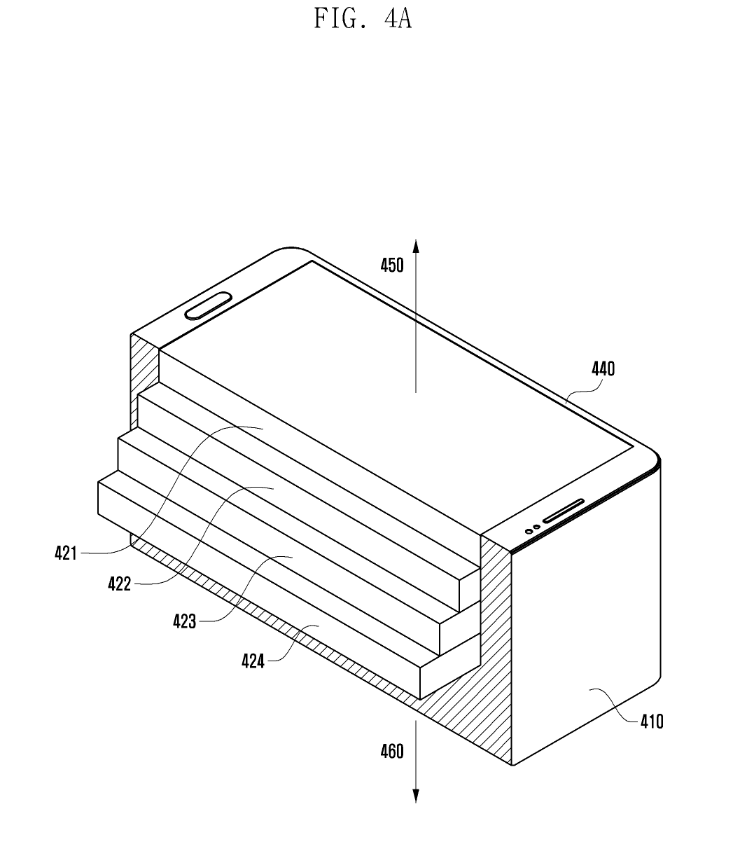

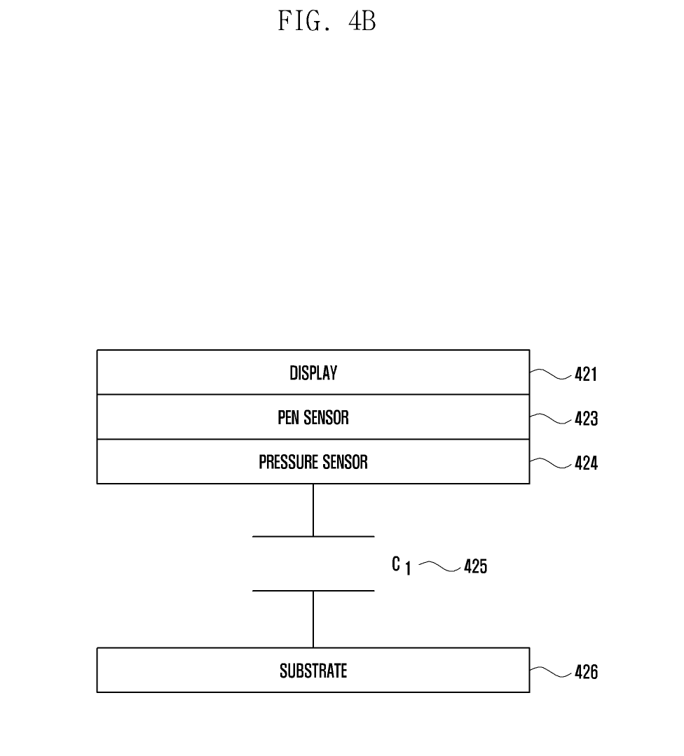

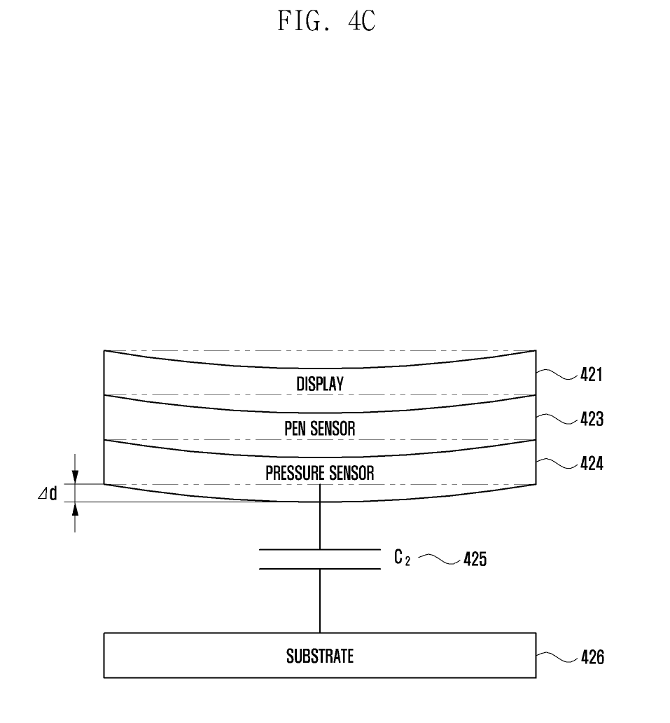

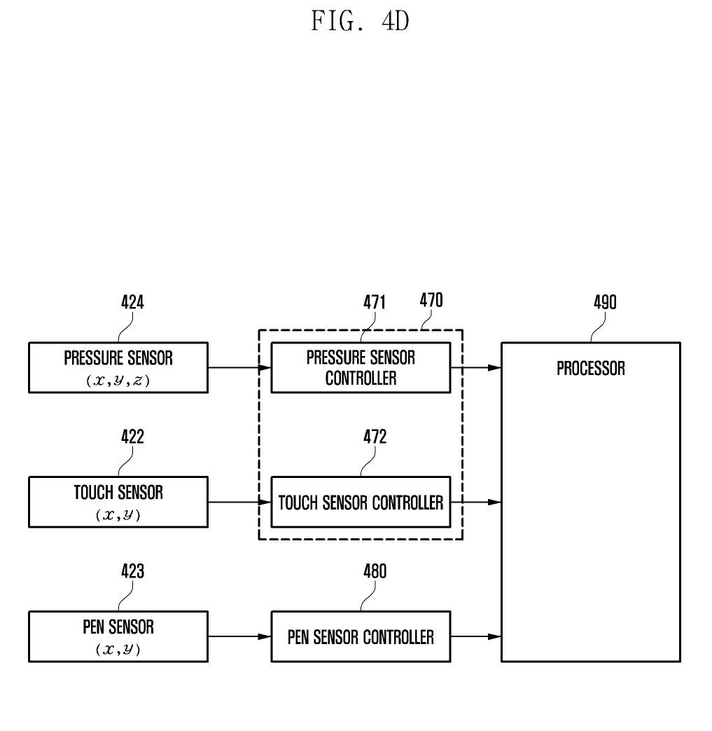

FIG. 4A is a block diagram showing the structure of an electronic device according to an embodiment of the present invention. The electronic device may include a housing 410, a display 421, a touch sensor 422, a pen sensor 423, and a pressure sensor 424.

In order to explain a stack structure of the display 421, the touch sensor 422, the pen sensor 423, and the pressure sensor 424, FIG. 4A depicts a state in which the electronic device is cut into a stepped form.

The housing 410 may include a first surface 440 facing a first direction 450 and a second surface (not shown) facing a second direction 460 opposite to the first direction 450.

The display 421 may be disposed between the first surface 440 and the second surface (not shown) of the housing 410 and may be exposed to the outside through the first surface 440. The display 421 may include a cover glass (not shown). The cover glass can transmit light generated by the display 421 while being exposed to the outside. The material of the cover glass is not limited. According to one embodiment, the cover glass may be formed of tempered glass, reinforced plastic, flexible polymeric material, or the like. For example, the cover glass may be made of one selected from or any combination of acrylonitrile butadiene styrene (ABS), acrylic, polycarbonate (PC), polymethyl methacrylate (PMMA), polyimide (PE), polyethylene terephthalate (PET), polypropylene terephthalate (PPT), amorphous polyethylene terephthalate (APET), polyethylene naphthalate terephthalate (PEN), polyethylene terephthalate glycol (PETG), tri-acetyl-cellulose (TAC), cyclic olefin polymer (COP), cyclic olefin copolymer (COC), polydicyclopentadiene (DCPD), cyclopentadiene anions (CPD), polyarylate (PAR), polyethersulfone (PES), poly ether imide (PEI), modified epoxy resin, or acrylic resin.

When an external object performs a touch input on the display, the touch sensor 422 may sense a position of the touch input on the display. Such touch inputs may include a contact input when the external object is in direct contact with the display 421, and a proximity input when the external object is placed in proximity to the display 421 without contact with the display 421.

The touch sensor 422 may use any technique of sensing the position of the touch input on the display. For example, using a resistive film technique, the touch sensor 422 may sense the touch input position on the display. In embodiments, the touch sensor 422 may be formed of a capacitive-type touch sensor and sense the touch input position on the display, based on a change in capacitance generated when the external object touches the display.

The touch sensor 422 may be disposed between the first surface 440 of the housing 410 and the display 421. Alternatively, the touch sensor 422 may be disposed within the display 421 and incorporated into the display 421.

The pen sensor 423 may be disposed between the display 421 and the second surface (not shown) of the housing 410 and may sense the touch input position of a stylus pen on the display.

In various embodiments of the present invention, the stylus pen may be referred to as a separate device that can be used to enter information to the electronic device. For example, the stylus pen may refer to a tool of generating an electromagnetic signal such that the pen sensor can sense the input position on the display by detecting the signal. In various embodiments, the stylus pen may include an electrode in a pen tip such that the pen sensor can sense the input position, based on a change in capacitance within the pen sensor according to the approach of the electrode. The stylus pen may be inserted detachably into the electronic device and, if necessary, be used after being separated from the electronic device.

The pressure sensor 424 may be disposed between the display 421 and the second surface of the housing 410 and configured to sense a pressure on the display caused by the touch input of the stylus pen or external object.

The pressure sensor 424 may recognize a change in a specified physical quantity (e.g., capacitance, resistance, etc.) caused by a touch of the external object and then convert the change in the physical quantity into a magnitude of a pressure.

The pressure sensor 424 may use any technique of sensing a touch position. In one embodiment, each of a plurality of pressure sensors constituting a pressure sensor layer may set corresponding position coordinate data. For example, the pressure sensors may be electrically connected to channels of a pressure sensor controller, respectively. When a pressure is applied, the pressure sensor controller may receive a signal from at least one of the plurality of pressure sensors through at least one channel. Then, using this channel, the pressure sensor controller may identify the at least one pressure sensor that recognizes the applied pressure, and thereby sense the touch position from the position coordinate data of the identified pressure sensor(s).

In various embodiments, the display 421, the touch sensor 422, the pen sensor 423, and the pressure sensor 424 may be arranged in a stack while sharing the same area. Although FIG. 4A shows a stacked order of the display 421, the touch sensor 422, the pen sensor 423, and the pressure sensor 424, the stacked order may be varied. In addition, any other element may be added, and some element (e.g., the pen sensor 423) may be omitted.

FIGS. 4B and 4C are diagrams showing a change of shape in an electronic device when an external object or a stylus pen performs a touch input on a display according to an embodiment of the present invention.

Referring to FIGS. 4B and 4C, in the electronic device, a capacitor 425 may be disposed between the pressure sensor 424 and a substrate 426.

Referring to FIG. 4C, when an external object (not shown) or a stylus pen (not shown) performs a touch input on the display 421, a pressure is generated by the touch input and thereby the shape of the display 421, the pen sensor 423, and the pressure sensor 424 may be changed in the direction of the pressure.

The touch sensor 422 may be incorporated into the display 421. In FIGS. 4B and 4C, the touch sensor 422 is incorporated into the display 421 to be included in the display 421.

In various embodiments, when the external object performs a touch input on the display 421, the touch sensor 422 may sense the position of the touch input on the display 421 by using a change in capacitance caused by the touch input.

A distance between a first electrode (e.g., the pressure sensor 424) and a second electrode (e.g., the substrate 426) included in the capacitor 425 may be varied by the pressure of the external object. Accordingly, the capacitance of the capacitor 425 after the pressure is applied may be different from the capacitance of the capacitor 425 before the pressure is applied. Assuming that a capacitance value of the capacitor 425 shown in FIG. 4B is C1, the distance between the first electrode (e.g., the pressure sensor 424) and the second electrode (e.g., the substrate 426) may be changed by the pressure corresponding to the touch input of the external object. Thus, the thickness of the capacitor is changed, and the capacitance value of the capacitor may be changed from C1 to C2. The pressure sensor 424 may measure a change in the capacitance value of the capacitor 425 and sense the magnitude of the pressure, based on the amount of change in the measured capacitance value.

FIG. 4D is a block diagram illustrating an electronic device according to an embodiment of the present invention.

Referring to FIG. 4D, the electronic device may include the touch sensor 422, the pen sensor 423, the pressure sensor 424, a pressure sensor controller 471, a touch sensor controller 472, a pen sensor controller 480, and a processor 490. The pressure sensor controller 471 and the touch sensor controller 472 may be included in an integrated circuit 470.

The touch sensor 422, the pen sensor 423, and the pressure sensor 424 may perform the same functions as those described in FIG. 4A.

The pressure sensor controller 471 may measure the magnitude (z) of a pressure, based on the amount of change in capacitance sensed by the pressure sensor 424. According to one embodiment, the pressure sensor controller 471 may also measure a pressure position (x, y) as well as the pressure magnitude (z). For example, the pressure sensor controller 471 may measure the pressure position (x, y), based on state information (e.g., contact with moisture, no operation of the touch sensor, etc.) of the electronic device received from the processor.

The touch sensor controller 472 may detect a touch position (x, y) of an external object on the display 421, based on a change in physical quantity sensed by the touch sensor 422.

The integrated circuit 470 may include the pressure sensor controller 471 and the touch sensor controller 472. The integrated circuit 470 may refer to a one-chip circuit into which the pressure sensor controller 471 and the touch sensor controller 472 are integrated at the manufacture of the electronic device according to an embodiment of the present invention.

The integrated circuit 470 may perform a function of synchronizing touch sensor data and pressure sensor data. This function may be performed by the processor 490.

The pen sensor controller 480 may measure a touch position (x, y) of a stylus pen on the display, based on a change in physical quantity sensed by the pen sensor 423.

The pen sensor controller 480 may be also integrated into the integrated circuit 470 together with the pressure sensor controller 471 and the touch sensor controller 472.

The processor 490 may perform the overall control of the electronic device in accordance with instructions stored in a memory (not shown).

According to one embodiment, when a touch input of the external object having a certain conductor is detected on the display, the processor 490 may determine a touch position of the external object on the display by using the touch sensor 422. For example, a user's finger 491 which is one of the external objects may correspond to a conductor. In this example, when a touch input is performed on the display 421 by the finger 491, the magnitude of capacitance between two electrodes included in the display 421 may be changed in response to the touch input.

According to another embodiment, when a touch input of the stylus pen is detected on the display, the processor 490 may determine a touch position of the stylus pen 492 on the display 421 by using the pen sensor 423. For example, the pen sensor 423 may sense the touch position of the stylus pen 492 by detecting a magnetic field signal output from the stylus pen. For example, the processor 490 may determine the touch position of the stylus pen 492 on the display 421, based on sensing results received from the pen sensor.

In case of failing to sense the touch position of the external object through the touch sensor 422 and/or the pen sensor 423, the processor 490 may use the pressure sensor 424 to determine the touch position corresponding to the touch input of the external object.

The case of failing to sense the external object through the touch sensor 422 and/or the pen sensor 423 may include a case where the external object is an object having no function of transmitting an electromagnetic signal, or a case where a liquid is in contact with at least a portion of the first surface 440 of the housing 410 and/or the display 421.

According to various embodiments, when a liquid is in contact with at least a portion of the first surface 440 and/or the display 421, this may cause noise with respect to a measurement value of current generated by a touch of conductor on the display 421.

According to various embodiments, the external object may be a ball-pen, which is not a conductor through which current flows, and may be made of a material that does not cause resonance by electromagnetic induction.

According to various embodiments, a touch position of the external object on the display 421 may not be determined using the touch sensor 422 and the pen sensor 423. However, the pressure sensor 424 may detect the magnitude of the pressure through a change in capacitance caused by the pressure, and thus determine the touch position of the external object on the display.

The processor 490 may determine whether the pressure sensed by the pressure sensor 424 is greater than a predetermined threshold. Then, based on determination results, the processor 490 may control at least one of the touch sensor 422, the pen sensor 423, and the pressure sensor 424 to sense the touch position of the external object or stylus pen on the display.

The processor 490 may synchronize the pressure data sensed by the pressure sensor 424 with the touch position corresponding to the touch input of the external object sensed by the touch sensor 422 or the pen sensor 423. The synchronized position and pressure data may be used to perform a function by the processor 490.

The processor 490 may perform at least one function, based on, at least in part, the position on the display 421 sensed by the touch sensor 422, the pen sensor 423 and/or the pressure sensor 424, and the magnitude of the pressure sensed by the pressure sensor 424.

The at least one function may refer to at least one of all functions executable in the electronic device. For example, the at least one function may include a call function, a camera function, and the like. The processor 490 may control to perform different functions depending on the magnitude of the pressure sensed by the pressure sensor 424. For example, if a pressure greater than the magnitude of the pressure corresponding to performing the call function is sensed by the pressure sensor 424, the processor 490 may control to make a call directly to a contact designated by a user of the electronic device.

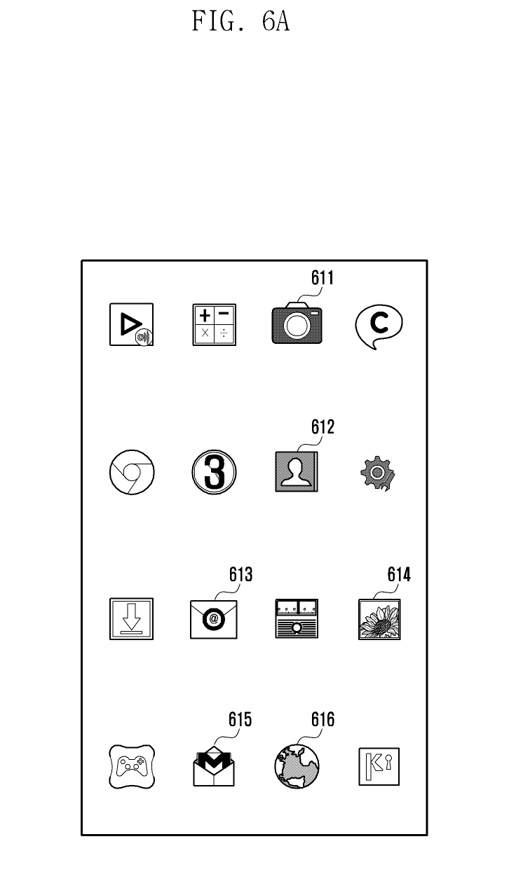

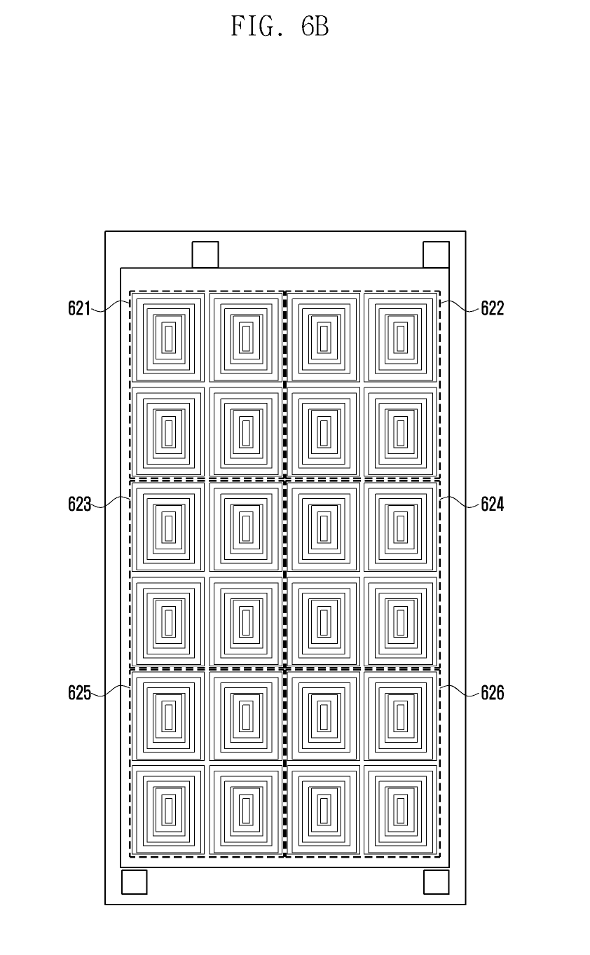

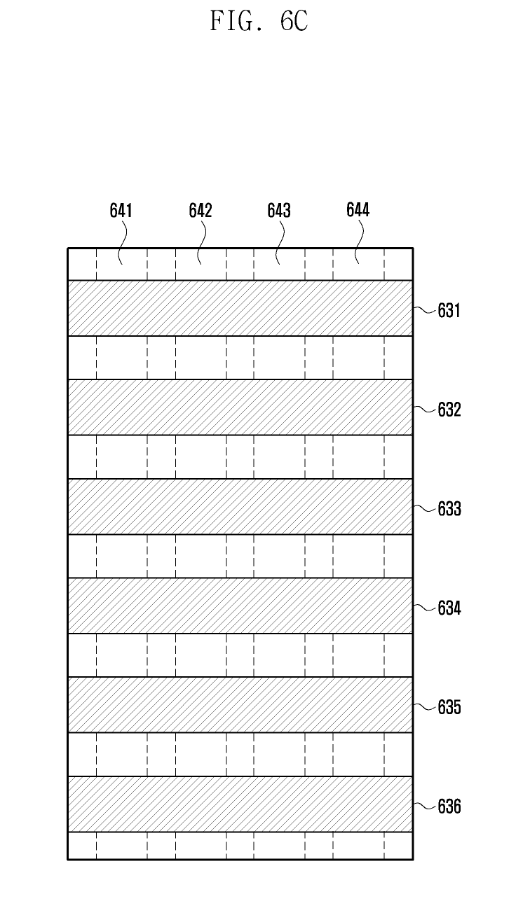

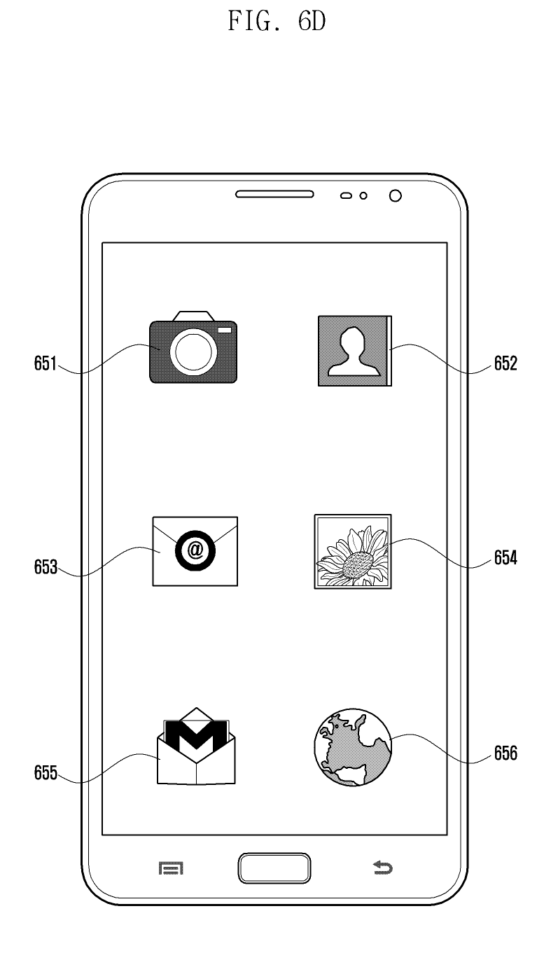

When the touch sensor 422 and/or the pen sensor 423 fails to sense a touch input by an external object for a predetermined time and when the pressure sensor 424 senses a pressure by the external object, the processor 490 may change a screen displayed on the display. The screen change may be varied depending on the arrangement of the pressure sensor. A related description will be made in detail in FIGS. 6A to 6D.

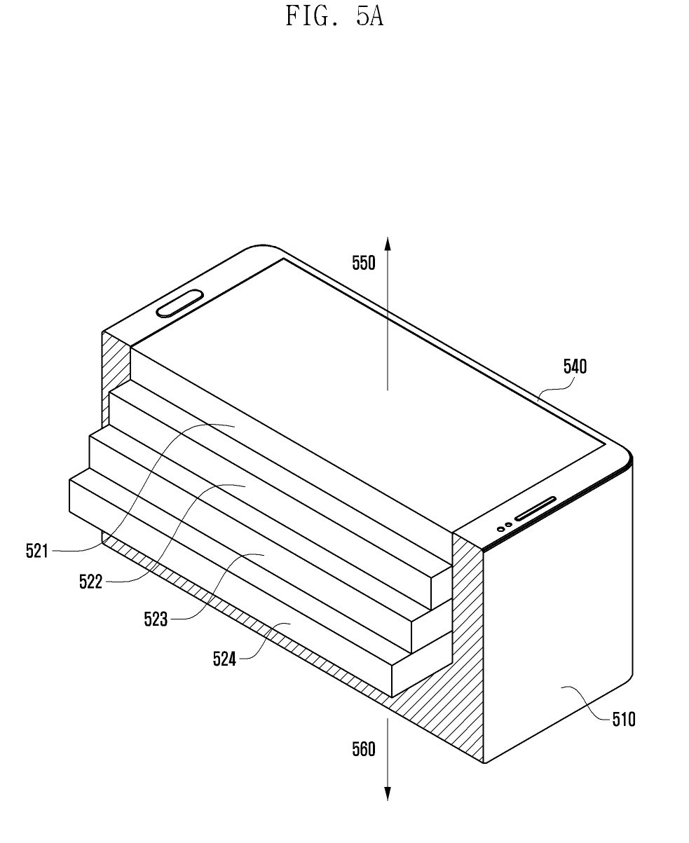

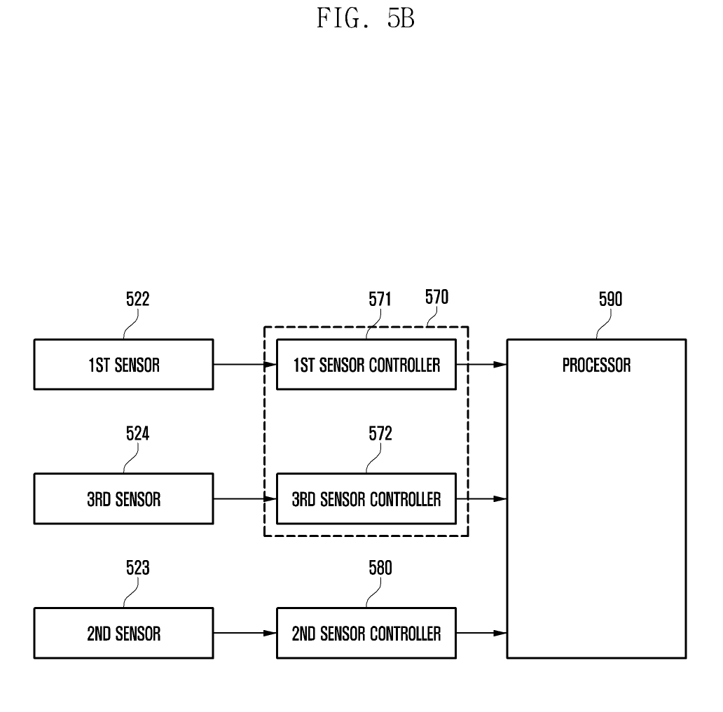

FIGS. 5A and 5B are diagrams illustrating the structure of an electronic device according to another embodiment of the present invention.

Referring to FIG. 5A, the electronic device according to another embodiment of the present invention may include a housing 510, a display 521, a first sensor 522, a second sensor 523, and a third sensor 524.

The housing 510 may include a first surface 540 corresponding to a first direction 550 and a second surface (not shown) corresponding to a second direction 560 opposite to the first direction 550.

The display 521 may be disposed between the first surface 540 and the second surface (not shown) of the housing 510 and may be exposed to the outside through the first surface 540. The display 521 may include a cover glass (not shown). The cover glass can transmit light generated by the display 521 while being exposed to the outside. The material of the cover glass is not limited. According to one embodiment, the cover glass may be formed of tempered glass, reinforced plastic, flexible polymeric material, or the like.

The first sensor 510 may be disposed between the first surface 540 and the second surface of the housing 510, sense, with a first resolution, a touch position corresponding to a touch input of an external object with respect to the display 521, and generate first coordinate data corresponding to the touch position based on sensing results. The touch input of the external object with respect to the display may include a contact input when the external object is in direct contact with the display 521, and a proximity input when the external object is placed in proximity to the display 521 without contact with the display 521.

The first sensor 522 may be disposed within the display 521 and incorporated into the display 521.

The second sensor 523 may be disposed between the first surface 540 and the second surface of the housing 510, sense, with a second resolution, the touch position corresponding to the touch input of the external object with respect to the display 521, and generate second coordinate data corresponding to the touch position based on sensing results.

The third sensor 524 may be disposed between the first surface 540 and the second surface of the housing 510, sense, with a third resolution, the touch position corresponding to the touch input of the external object with respect to the display 521, and generate third coordinate data corresponding to the touch position based on sensing results. In addition, the third sensor 524 may sense a pressure applied to the display 521 by the touch input.

The first resolution, the second resolution, and the third resolution may indicate the degree of accurately sensing the touch position corresponding to the touch input on the display 521. The higher the value corresponding to the resolution, the more accurately the touch position on the display 521 can be sensed.

Although FIG. 5A shows that the first sensor 522, the second sensor 523, and the third sensor 524 are stacked in order, the stacked order is not limited. For example, the display 521, the second sensor 523, the first sensor 522, and the third sensor 524 may be stacked in order from the first surface 540.

FIG. 5B is a block diagram of an electronic device according to another embodiment of the present invention.

As shown in FIG. 5B, the electronic device according to another embodiment of the present invention may include the first sensor 522, the second sensor 523, the third sensor 524, a circuit 570 having a first sensor controller 571 and a third sensor controller 572, a second sensor controller 580, and a processor 590.

The first sensor 522, the second sensor 523, and the third sensor 524 may perform the same functions as those described in FIG. 5A.

The first sensor controller 571 may detect the touch position corresponding to the touch input of the external object with respect to the display 521, based on a change in physical quantity sensed by the first sensor 522.

The second sensor controller 572 may detect the touch position corresponding to the touch input of the external object with respect to the display 521, based on a change in physical quantity sensed by the second sensor 523.

The first sensor controller 571 and the third sensor controller 572 may be fabricated as one chip 570 and inserted into the electronic device. In addition, the one chip 570 may synchronize the first coordinate data and the second coordinate data transmitted from the first sensor and the second sensor.

According to various embodiments, any one or more of the first sensor controller 571, the second sensor controller 580, and the third sensor controller 572 may be fabricated as an integrated circuit and embedded in the electronic device.

The processor 590 may control the electronic device, based on instructions stored in a memory (not shown).

The processor 590 may determine the touch position corresponding to the touch input of the external object with respect to the display 521, based on, at least in part, first coordinate data received from the first sensor 522, second coordinate data received from the second sensor 523, and third coordinate data received from the third sensor 524. In addition, the processor 590 may determine the pressure applied to the display 521 by the external object, based on pressure data received from the third sensor 524.

According to various embodiments of the present invention, in case of failing to receive the second coordinate data from the second sensor 523 even though receiving the first coordinate data and the third coordinate data from the first sensor 522 and the third sensor 524, the processor 590 may control to perform a first operation based on, at least in part, the first coordinate data.

The second sensor 523 may sense the touch position of the external object on the display 521 at the second resolution, based on the electromagnetic induction phenomenon caused by the electromagnetic wave outputted from the external object, and generate the second coordinate data corresponding to the sensed position. When the external object does not output the electromagnetic wave, the second sensor 523 may not generate the second coordinate data. However, when the first sensor 522 and the third sensor 524 detect the touch input of the external object with respect to the display, the processor 590 may control to perform the first operation on the basis of the first coordinate data.

According to various embodiments of the present invention, in case of failing to receive the first coordinate data from the first sensor 522 even though receiving the second coordinate data and the third coordinate data from the second sensor 523 and the third sensor 524, the processor 590 may control to perform the first operation based on, at least in part, the second coordinate data. When the external object formed of an insulator and having the characteristic of generating the electromagnetic wave performs the touch input to the display 521, the second sensor 523 and the third sensor 524 may generate the second coordinate data and the third coordinate data, respectively. However, the first sensor 522 may not generate the first coordinate data due to the characteristics of the external object formed of the insulator. In this case, the processor 590 may control to perform the first operation using the second coordinate data.

According to various embodiments of the present invention, in case of failing to receive the first coordinate data and the second coordinate data from the first sensor 522 and the second sensor 523, respectively, even though receiving the third coordinate data from the third sensor 524, the processor 590 may control to perform the first operation based on, at least in part, the third coordinate data. When the touch input to the display 521 is performed using the external object having the characteristics of an insulator and failing to generate the electromagnetic field, the first sensor 522 and the second sensor 523 may not generate the first coordinate data and the second coordinate data. This is because the external object is an insulator and does not generate the electromagnetic wave. In this case, based on the magnitude and position of the pressure formed on the display 521 by the touch input of the external object having the characteristic of an insulator and not generating the electromagnetic field, the third sensor 524 may generate the pressure data and the third coordinate data. Also, based on the third coordinate data, the processor 590 may control to perform the first operation.

The processor 590 may control the electronic device by using one of the first coordinate data, the second coordinate data, and the third coordinate data, and using the pressure data generated by the third sensor 524.

The third sensor controller 572 may be connected between the third sensor 524 and the processor 590 and may receive the pressure data and the third coordinate data from the third sensor 524. The received pressure data may be transmitted to an application processor (AP) included in the processor 590.

The processor 590 may further include an integrated circuit electrically coupled between the application processor and the third sensor 524. The integrated circuit may transmit the third coordinate data to the application processor at the request of the application processor. In case of failing to receive the first coordinate data from the first sensor 522 and also failing to receive the second coordinate data from the second sensor 523, the application processor may request the integrated circuit to transmit the third coordinate data. Upon receiving the request, the integrated circuit may transmit the third coordinate data to the application processor.

FIGS. 6A to 6D are diagrams illustrating the operation of an electronic device according to an embodiment of the present invention.

FIG. 6A shows UI objects, for example, an array of icons 611 to 616 corresponding to applications, outputted on the display of the electronic device according to one embodiment of the present invention.

According to one embodiment, the resolution of the pressure sensor 424 sensing the touch may be smaller than the resolution of the touch sensor 422 and/or the resolution of the pen sensor 423. That is, the accuracy of recognizing the touch position by using only the pressure sensor 424 may be lower than the accuracy of sensing the touch position by using the touch sensor 422 and/or the pen sensor 423.

According to another embodiment, in the electronic device including the first sensor, the second sensor, and the third sensor which sense the touch position corresponding to the touch input of the external object with respect to the display at the first resolution, the second resolution, and the third resolution, respectively, the third resolution may be smaller than the first resolution and/or the second resolution. That is, the accuracy of recognizing the touch position by using only the third sensor may be lower than the accuracy of sensing the touch position by using the first sensor and/or the second sensor.

When the touch sensor and/or the pen sensor fail to sense the touch by the external object for a predetermined time, and when the pressure sensor senses the pressure by the external object, the electronic device may change the screen outputted on the display. In case of failing to sense the touch position of the external object on the display from the touch sensor and/or the pen sensor, the processor may determine whether to change or not the screen outputted on the display before, when, or after acquiring the position and pressure coordinates on the display from the pressure sensor.

According to various embodiments of the present invention, when a mode designated by the user of the electronic device is executed, the processor may determine to change the screen outputted on the display.

According to an embodiment of the present invention, when a waterproof mode designated by the user is executed, the screen outputted on the display may be changed. If a conductive liquid exists on the display when the external object is touched on the display, it is difficult to accurately measure a change in current flowing on the display surface due to the characteristics of the conductive liquid. The waterproof mode may refer to a mode of using the touch position of the external object through the pressure sensor by considering the characteristics of the conductive liquid.

According to an embodiment of the present invention, when a glove wearing mode is executed, the processor may determine to change the screen outputted on the display. The glove wearing mode may refer to a mode of using the touch position of the external object on the display through the pressure sensor by considering the user wearing the glove on hand.

According to an embodiment of the present invention, when the magnitude of the pressure sensed by the pressure sensor is greater, the processor may determine to change the screen outputted on the display. For example, when a change in the magnitude of a force applied to the display by the external object is greater than a predetermined threshold, the arrangement or sizes of the UI objects outputted on the display may be changed.

According to an embodiment of the present invention, the electronic device may measure at least one of a reflection angle or a refraction angle of infrared rays emitted from an infrared sensor installed in the electronic device in order to determine whether there is a liquid. If so, the processor may determine to change the screen outputted on the display. Changing the screen may include changing the size of the UI object on the display, changing the arrangement of the UI objects, or adjusting the number of the UI objects.

According to various embodiments of the present invention, the screen outputted on the display may be changed differently, based on the arrangement of the pressure sensor. This is because when the touch position is detected by using the pressure sensor, the accuracy varies depending on the position of the pressure sensor. For example, the closer the pressure sensor is placed to the outer surface of the housing, the higher the accuracy can be.

FIGS. 6B and 6C are diagrams illustrating an embodiment of a pattern for disposing the pressure sensors.

Referring to FIG. 6B, the pressure sensors 621 to 626 are arranged in a square pattern (i.e., SELF-CAP type). In FIG. 6B, electrodes of different sizes are formed of a single rectangular pattern, and these rectangular patterns are arranged in a 4*6 array. However, the present invention is not limited to the arrangement of the pressure sensors shown in FIG. 6B, and may be arranged in various patterns such as a circular pattern.

FIG. 6C is a diagram illustrating another embodiment of a pattern for disposing the pressure sensors. Referring to FIG. 6C, electrodes 631 to 636 each of which forms a capacitor are arranged in a pattern (i.e., Mutual-Cap type) in which long narrow bands are arranged widthwise. Also, other electrodes 641 to 644 each of which forms the capacitor are arranged in a pattern in which long narrow bands are arranged lengthwise. That is, the pressure sensors each formed of both electrodes are arranged in a 4*6 array. In the electronic device, application icons may be disposed on the display to correspond to locations of the pressure sensors. FIG. 6D shows an example in which application icons 611 to 616 are disposed at positions on the display corresponding to the locations of the pressure sensors shown in FIGS. 6B and 6C.

Referring to FIG. 6D, an icon 651 is disposed at a position on the display corresponding to the location of a pressure sensor 621. Also, another icon 652 is disposed at a position on the display corresponding to the location of another pressure sensor 622.

According to various embodiments of the present invention, in case of sensing a pressure without sensing a touch input of the external object on the display, it is possible to change the sizes and positions of the UI objects depending on the arrangement of the pressure sensors. For example, when the application icons are displayed as shown in FIG. 6A, these displayed icons may be changed as shown in FIG. 6D in response to a pressure input.

The icons 651 to 656 shown in FIG. 6D may correspond to the icons 611 to 616 shown in FIG. 6A.

According to various embodiments of the present invention, applications corresponding to the changed icons on the display may be specific applications frequently used by the user of the electronic device. The processor may determine the frequently used applications, based on usage patterns or frequencies of applications used in the electronic device. When the position corresponding to the touch input of the external object with respect to the display is not detected and the pressure is sensed, the processor may change the sizes and positions of the icons corresponding to the frequently used applications.

An electronic device according to an embodiment of the present invention may comprise a housing including a first surface facing a first direction and a second surface facing a second direction opposite to the first direction; a display disposed between the first and second surfaces of the housing and exposed through the first surface; a touch sensor disposed between the first surface of the housing and the display or within the display, and configured to sense a position on the display, the touch being performed by an external object; a pen sensor disposed between the display and the second surface of the housing, and configured to sense a touch position of a stylus pen on the display; a pressure sensor disposed between the pen sensor and the second surface of the housing, and configured to sense a pressure of the external object on the display; at least one processor electrically connected to the display, the touch sensor, the pen sensor, and the pressure sensor; and at least one memory electrically connected to the at least one processor, wherein the at least one memory stores instructions causing the at least one processor to: sense a pressure of the external object with respect to the display by using the pressure sensor, sense a touch position of the external object by using the touch sensor when the external object includes a conductor, sense the touch position of the external object by using the pen sensor when the external object is a stylus pen configured to be capable of transmitting an electromagnetic signal to the pen sensor, sense the touch position of the external object by using the pressure sensor in case of failing to sense the external object through the touch sensor and/or the pen sensor, and perform at least one function, based on, at least in part, the touch position sensed by the touch sensor, the pen sensor, and/or the pressure sensor, and the pressure sensed by the pressure sensor.

In the electronic device according to an embodiment of the present invention, the case of failing to sense the external object through the touch sensor and/or the pen sensor may include at least one of a case where the external object is an insulator incapable of transmitting an electromagnetic signal to the pen sensor, or a case where moisture is contacted to at least a part of the first surface of the housing.

In the electronic device according to an embodiment of the present invention, the at least one memory may further store instructions causing the at least one processor to sense the touch position by using the touch sensor, the pen sensor, and/or the pressure sensor, based on a determination that the sensed pressure is greater than a threshold.

In the electronic device according to an embodiment of the present invention, the at least one memory may further store instructions causing the at least one processor to change a screen outputted on the display when the touch sensor and/or the pen sensor fail to sense a touch by the external object and when the pressure sensor senses the pressure by the external object for a selected time.

In the electronic device according to an embodiment of the present invention, the at least one memory may further store instructions causing the at least one processor to change the screen, based on, at least in part, an arrangement pattern of the pressure sensor.

An electronic device according to another embodiment of the present invention may comprise a housing including a first surface facing a first direction and a second surface facing a second direction opposite to the first direction; a display disposed between the first and second surfaces of the housing and exposed through the first surface; a first sensor disposed between the first and second surfaces of the housing, and configured to sense a touch position of an external object with respect to the display at a first resolution and thereby generate first coordinate data; a second sensor disposed between the first and second surfaces of the housing, and configured to sense the touch position at a second resolution, perform a sensing in a different manner of the first sensor, and thereby generate second coordinate data; a third sensor disposed between the first and second surfaces of the housing, and configured to sense at a third resolution the touch position and pressure data applied to the display by the external object and thereby generate third coordinate data; at least one processor electrically connected to the display, the first sensor, the second sensor, and the third sensor; and at least one memory electrically connected to the at least one processor, wherein the at least one memory stores instructions causing the at least one processor to: when the external object is in contact with the display, perform a first operation based on, at least in part, the first coordinate data, when the first coordinate data and the third coordinate data are received from the first sensor and the third sensor, respectively, and when the second coordinate data is not received from the second sensor, perform the first operation based on, at least in part, the second coordinate data, when the second coordinate data and the third coordinate data are received from the second sensor and the third sensor, respectively, and when the first coordinate data is not received from the first sensor, and perform the first operation based on, at least in part, the third coordinate data, when the third coordinate data is received from the third sensor, and when the first coordinate data and the second coordinate data are not received from the first sensor and the second sensor, respectively.

In the electronic device according to another embodiment of the present invention, the at least one processor may include an application processor; and an integrated circuit (IC) electrically coupled between the third sensor and the application processor.

In the electronic device according to another embodiment of the present invention, the integrated circuit may be configured to receive the pressure data and the third coordinate data from the third sensor, receive a request for the third coordinate data from the application processor when the application processor fails to receive the first coordinate data and the second coordinate data from the first sensor and the second sensor, respectively, and transmit the third coordinate data to the application processor in response to the received request.

In the electronic device according to another embodiment of the present invention, the third resolution may be smaller than the first resolution and/or the second resolution.

In the electronic device according to another embodiment of the present invention, the first sensor may be configured to sense the touch position at the first resolution and thereby generate the first coordinate data when the external object includes a conductor.

In the electronic device according to another embodiment of the present invention, the second sensor may be configured to sense the touch position at the second resolution, perform the sensing in a different manner from the first sensor, and thereby generate the second coordinate data when the external object is capable of emitting an electromagnetic signal to an outside.

In the electronic device according to another embodiment of the present invention, the at least one memory may further store instructions causing the at least one processor to change a screen outputted on the display when the first sensor and/or the second sensor fail to sense the touch position for a predetermined time and when the third sensor senses the pressure by the external object.

In the electronic device according to another embodiment of the present invention, the at least one memory may further store instructions causing the at least one processor to change the screen, based on an arrangement of the third sensor.

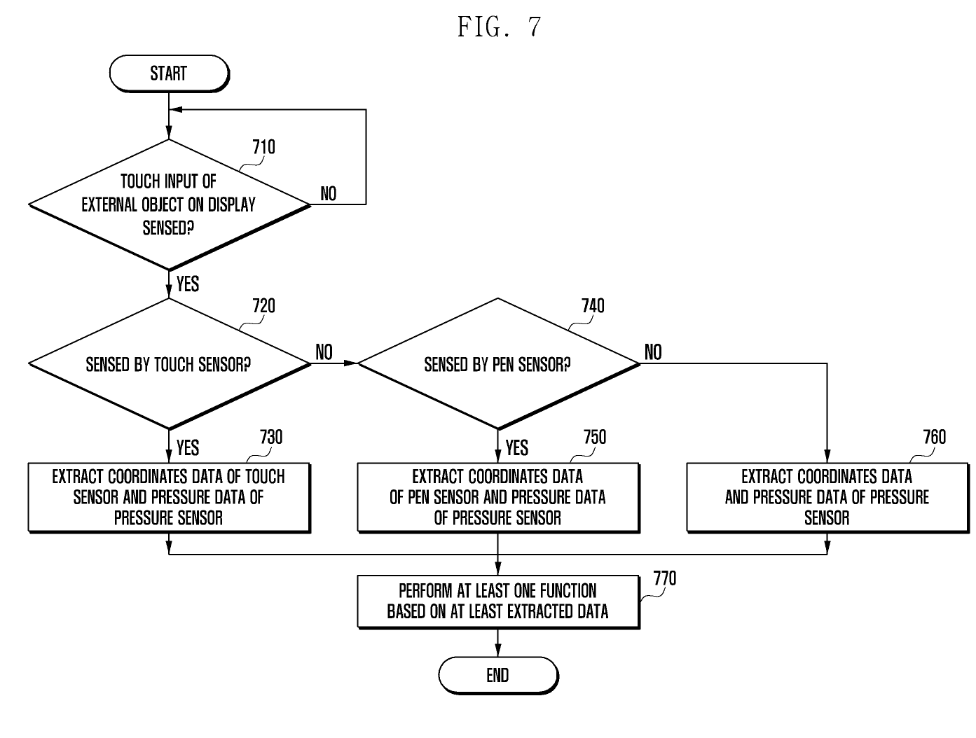

FIG. 7 is a flow diagram illustrating an operating method of an electronic device according to an embodiment of the present invention.

Referring to FIG. 7, the method of operating the electronic device according to an embodiment of the present invention may include operations 710 to 770. These operations 710 to 770 may be performed, for example, by the electronic device shown in FIG. 4A. For example, each of the operations 710 to 770 may be implemented with instructions that may be performed or executed by the processor 490 of the electronic device. The instructions may be stored, for example, in a memory of the electronic device.

At operation 710, the electronic device may determine whether a touch input of an external object is sensed on the display 421.

Any one or more of the touch sensor 422, the pen sensor 423, and the pressure sensor 424 may sense a touch position corresponding to the touch input of the external object with respect to the display 421.

In one embodiment, the pressure sensor 424 may sense the touch input of the external object on the display, based on the result of sensing a pressure.

In one embodiment, the touch sensor 422 may sense on the display 421 the touch input of the external object having the characteristics of a conductor.

In one embodiment, the pen sensor 423 may sense on the display the touch input of the external object outputting the electromagnetic field and having the characteristics of generating the electromagnetic induction phenomenon with the pen sensor.

At operation 720, the electronic device may determine whether the touch sensor 422 senses the touch input. When the touch sensor 422 senses the touch input, the electronic device may extract the coordinate data of the touch sensor 422 and the pressure data of the pressure sensor 424 at operation 730.

When the touch sensor 422 fails to sense the touch input or when the accuracy of a position corresponding to the touch input recognized by the touch sensor 422 is lower than a predetermined threshold, the electronic device may determine at operation 740 whether the pen sensor 423 senses the touch position.

When it is determined that the pen sensor 423 senses the touch position, the electronic device may extract the coordinate data of the pen sensor 423 and the pressure data of the pressure sensor 424 at operation 750.

When the touch sensor 422 and the pen sensor 423 fail to sense the touch position, the electronic device may extract the coordinate data and the pressure data of the pressure sensor 424 at operation 760.

At operation 770, the processor 490 may perform at least one function, based on, at least in part, the coordinate data extracted from one or more of the touch sensor 422, the pen sensor 423, and the pressure sensor 424, and the pressure data of the pressure sensor.

According to one embodiment, the at least one function may include a function of changing the screen outputted on the display when the touch sensor 422 and/or the pen sensor 423 fail to sense the touch by the external object for a predetermined time and when the pressure sensor senses the pressure. This has been previously described in FIGS. 6A to 6D.

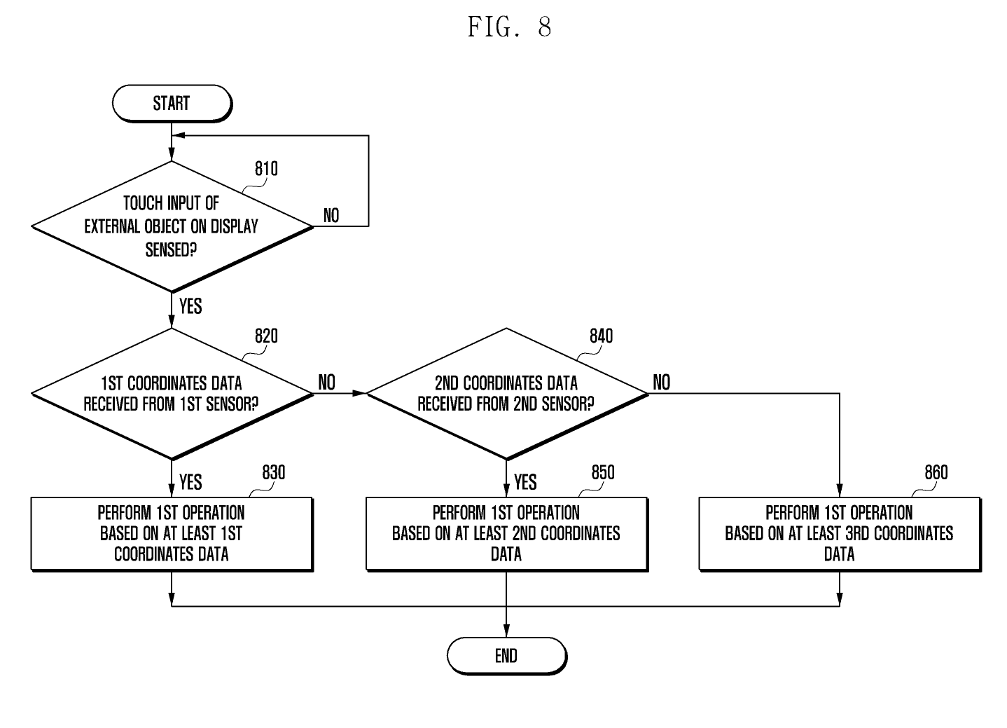

FIG. 8 is a flow diagram illustrating an operating method of an electronic device according to another embodiment of the present invention.

Referring to FIG. 8, the method of operating the electronic device according to another embodiment of the present invention may include operations 810 to 860. These operations 810 to 860 may be performed, for example, by the electronic device shown in FIG. 4B. For example, each of the operations 810 to 860 may be implemented with instructions that may be performed or executed by the processor 590 of the electronic device. The instructions may be stored, for example, in a memory of the electronic device.

At operation 810, the electronic device may determine whether one of the first sensor 522, the second sensor 523 and the third sensor 524 senses a touch input of an external object on the display 421.

In one embodiment, the third sensor 524 may recognize the touch input of the external object with respect to the display 521. The third sensor 524 may generate third coordinate data corresponding to the recognized touch input and transmit the third coordinate data to the processor 590.

When the touch input of the external object is sensed on the display 521, the electronic device may determine at operation 820 whether the first coordinate data is received from the first sensor 510.

According to one embodiment, when the first sensor 522 recognizes the touch input of the external object on the display 521, the first sensor 522 may generate the first coordinate data corresponding to the touch input. The generated first coordinate data may be transmitted to the processor 590.

When the first coordinate data is received, the processor 590 may perform a first operation at operation 830, based on, at least in part, the first coordinate data.

When the first coordinate data is not received from the first sensor 522, the processor 590 may determine at operation 840 whether the second coordinate data is received from the second sensor 523.

According to one embodiment, when the second sensor 523 recognizes the touch input of the external object on the display 521, the second sensor 523 may generate the second coordinate data corresponding to the touch input. The generated second coordinate data may be transmitted to the processor 590.

When the second coordinate data is received, the processor 590 may perform the first operation at operation 850, based on, at least in part, the second coordinate data.

When failing to receive the first coordinate data from the first sensor and also failing to receive the second coordinate data from the second sensor, the processor 590 may perform the first operation at operation 860, based on, at least in part, the third coordinate data received from the third sensor.

Before performing the operation 860, the processor 590 may change the screen outputted on the display. When failing to receive the first coordinate data and the second coordinate data from the first sensor and the second sensor, the processor 590 may change the screen outputted on the display. The change of screen may be varied depending on the arrangement of the third sensor. This has been previously described in FIGS. 6A to 6D.

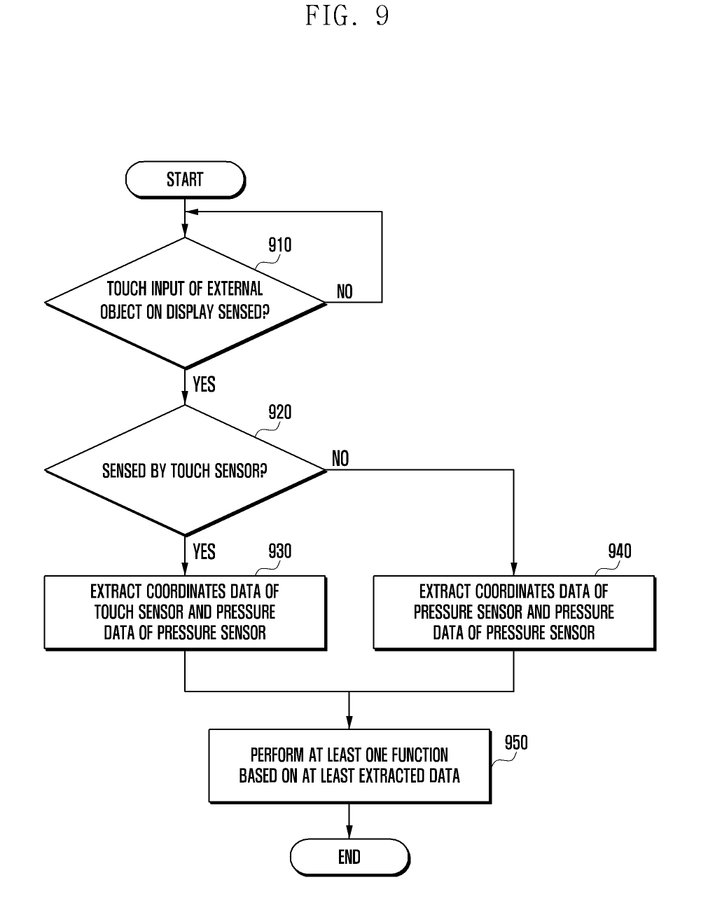

FIG. 9 is a flow diagram illustrating an operating method of an electronic device according to still another embodiment of the present invention.

Referring to FIG. 9, the method of operating the electronic device according to still another embodiment of the present invention may include operations 910 to 950. These operations 910 to 950 may be performed, for example, by the electronic device shown in FIG. 4B and having no pen sensor. For example, each of the operations 910 to 950 may be implemented with instructions that may be performed or executed by the processor of the electronic device. The instructions may be stored, for example, in a memory of the electronic device.

At operation 910, the processor may determine whether a touch input of an external object is sensed on the display 421.

According to one embodiment, based on a result that the pressure sensor 424 senses a pressure generated by the touch input of the external object on the display 421, the processor may determine whether a contact between the external object and the display 421 is sensed.

When the touch input of the external object is sensed on the display, the processor may determine at operation 920 whether the touch sensor 422 senses the touch input.

When the touch sensor 422 senses the touch input, the electronic device may extract the coordinate data of the touch sensor 422 and the pressure data of the pressure sensor 424 at operation 930.

Although not shown, the coordinate data of the touch sensor 422 and the pressure data of the pressure sensor 424 may be synchronized by the processor.

When the touch sensor 422 fails to sense the touch input, the electronic device may extract the coordinate data and the pressure data of the pressure sensor 424 at operation 940.

At operation 950, the processor may perform at least one function, based on, at least in part, the data extracted from the touch sensor 422 and/or the pressure sensor 424.

According to one embodiment, the at least one function may include a function of changing the screen outputted on the display when the touch sensor 422 fails to sense the touch by the external object for a predetermined time and when the pressure sensor 424 senses the pressure by the external object. This has been previously described in FIGS. 6A to 6D.

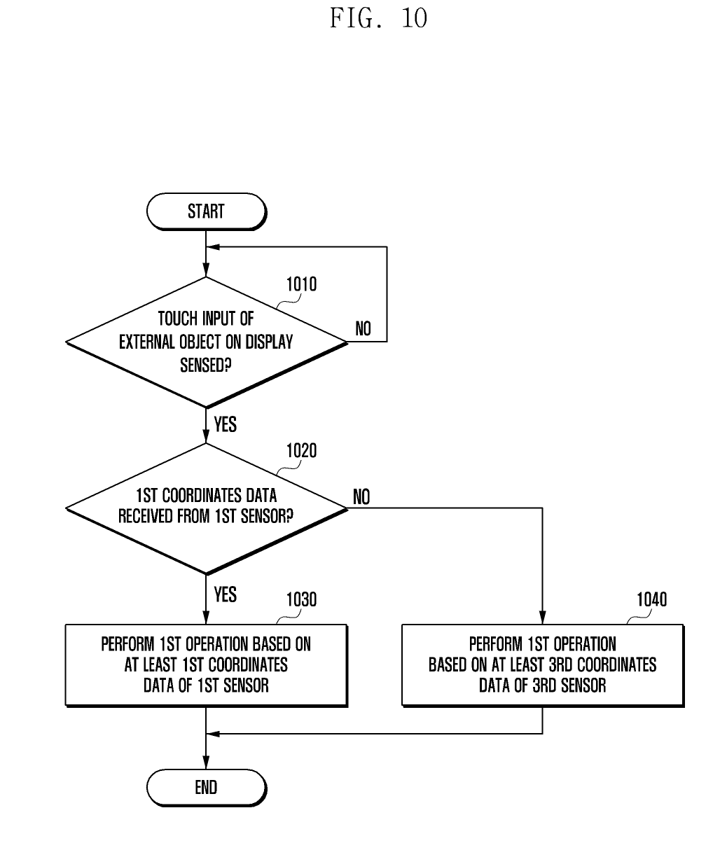

FIG. 10 is a flow diagram illustrating an operating method of an electronic device according to yet another embodiment of the present invention.

Referring to FIG. 10, the method of operating the electronic device according to yet another embodiment of the present invention may include operations 1010 to 1040. These operations 1010 to 1040 may be performed, for example, by the electronic device shown in FIG. 5B and having no second sensor 523. For example, each of the operations 1010 to 1040 may be implemented with instructions that may be performed or executed by the processor of the electronic device. The instructions may be stored, for example, in a memory of the electronic device.

At operation 1010, the electronic device may determine whether a touch input of an external object is sensed on the display.

According to one embodiment, when the third sensor 524 senses a pressure, the electronic device may determine that the touch input of the external object is sensed on the display. At operation 1020, the electronic device may determine whether the first coordinate data corresponding to the touch input is received from the first sensor 522. When the first coordinate data is received from the first sensor 522, the electronic device may perform the first operation based on, at least in part, the first coordinate data of the first sensor 522 at operation 1030.

When failing to receive the first coordinate data from the first sensor 522, the electronic device may perform the first operation based on, at least in part, the third coordinate data of the third sensor 524 at operation 1040.

According to one embodiment, the at least one function may include a function of changing the screen outputted on the display when the first sensor 522 fails to sense the touch by the external object for a predetermined time and when the third sensor 524 senses the pressure by the external object. This has been previously described in FIGS. 6A to 6D.

A method of operating an electronic device according to an embodiment of the present invention may comprise sensing a touch of the external object with respect to the display; performing a first operation based on, at least in part, first coordinate data, when the first coordinate data and third coordinate data are received from the first sensor and the third sensor, respectively, and when second coordinate data is not received from the second sensor; performing the first operation based on, at least in part, the second coordinate data, when the second coordinate data and the third coordinate data are received, and when the first coordinate data is not received; and performing the first operation based on, at least in part, the third coordinate data, when the third coordinate data is received, and when the first coordinate data and the second coordinate data are not received.

In the method according to an embodiment of the present invention, the processor may include an application processor; and an integrated circuit (IC) electrically coupled between the third sensor and the application processor.

In the method according to an embodiment of the present invention, the integrated circuit may be configured to receive the pressure data and the third coordinate data from the third sensor, receive a request for the third coordinate data from the application processor when the application processor fails to receive the first coordinate data and the second coordinate data from the first sensor and the second sensor, respectively, and transmit the third coordinate data to the application processor in response to the received request.

In the method according to an embodiment of the present invention, the third resolution may be smaller than the first resolution and/or the second resolution.

In the method according to an embodiment of the present invention, the first sensor may be configured to sense the touch position at the first resolution and thereby generate the first coordinate data when the external object includes a conductor.

In the method according to an embodiment of the present invention, the second sensor may be configured to sense the touch position at the second resolution, perform the sensing in a different manner from the first sensor, and thereby generate the second coordinate data when the external object is capable of emitting an electromagnetic signal to an outside.

The method according to an embodiment of the present invention may further comprise changing a screen outputted on the display when the first sensor and/or the second sensor fail to sense a touch by the external object for a predetermined time and when the third sensor senses a pressure by the external object.

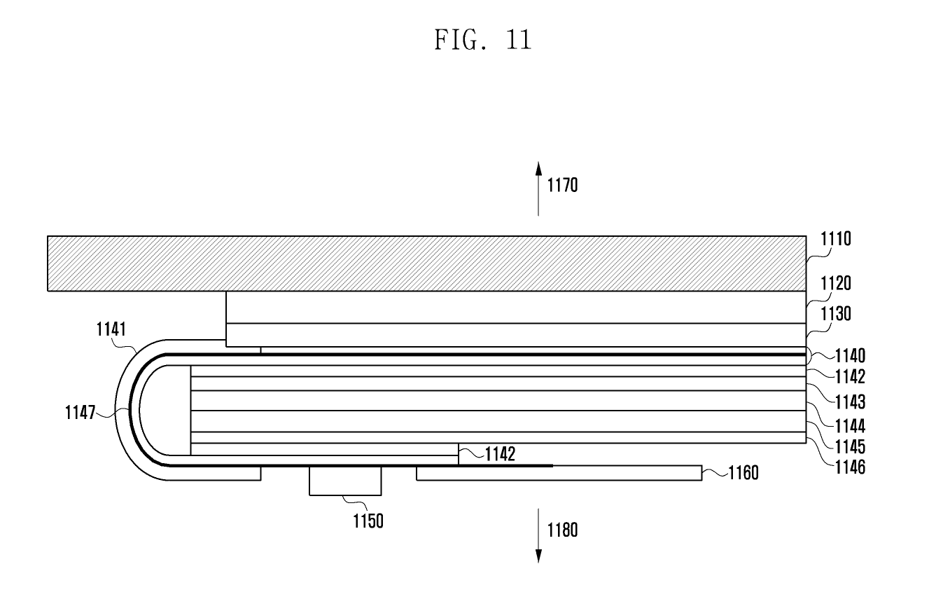

FIG. 11 is a diagram illustrating the structure of an electronic device according to still another embodiment of the present invention.

Referring to FIG. 11, the electronic device according to this embodiment of the present invention may include a housing (not shown), a display 1140, a touch sensor (not shown), a pen sensor 1144, and a pressure sensor 1145. Also, the electronic device may include a cover window 1110, an optical adhesive film (or optical clear adhesive) 1111, and a polarizing film (POL) 1112.

The optical adhesive film 1111 may attach layers existing in a first direction 1170 and a second direction 1180.

The polarizing film 1112 may correspond to a layer formed of a material capable of changing the direction of light outputted from the display 1140.

Depending on a designer's intent, the touch sensor (not shown) may be integrated into the display 1140. In FIG. 11, the touch sensor is integrated into the display 1140.

The display 1140 may include an active area in which an image is displayed, and an inactive area in which no image is displayed. At least a portion of the inactive area may be folded in the second direction 1180.

The display 1140 may include a first polymer layer 1141 and a second polymer layer 1142. The first polymer layer 1141 may perform a function of relieving a bending stress applied to the display. The second polymer layer 1142 may exist in the folded portion of the display and may have a first portion disposed in at least a part of the active area and a second portion disposed in at least a part of the inactive area.

Referring to FIG. 11, in various embodiments, the pen sensor 1144 and the pressure sensor 1145 may be disposed at least partially between the first and second portions of the second polymer layer.

In one embodiment, the touch sensor, the pen sensor, and the pressure sensor may be disposed at least partially between the first and second portions of the second polymer layer.

Referring to FIG. 11, a cushion 1143, the pen sensor 1144, the pressure sensor 1145, and an electrode layer 1146 may be stacked in a space created when the second polymer layer 1142 is bent. A stacked order shown in FIG. 11 is an example only, and the stacked order may be changed according to the designer's intention. Some layers may be added or omitted to or from the structure.

A display driver integrated circuit 1150 and a circuit board 1160 may be stacked on a lower folded portion of the inactive area of the display 1140. The display 1140 may be electrically coupled to the driver integrated circuit 1150 and the circuit board 1160 via a line 1147 existing under the first polymer layer 1141.

In a computer recording medium storing computer-readable instructions according to an embodiment disclosed herein, the instructions may comprise operations of sensing a pressure of the external object with respect to the display by using the pressure sensor, sensing a touch position of the external object by using the touch sensor when the external object includes a conductor, sensing the touch position of the external object by using the pen sensor when the external object is a stylus pen configured to be capable of transmitting an electromagnetic signal to the pen sensor, sensing the touch position of the external object by using the pressure sensor in case of failing to sense the external object through the touch sensor and/or the pen sensor, and performing at least one function, based on, at least in part, the touch position sensed by the touch sensor, the pen sensor, and/or the pressure sensor, and the pressure sensed by the pressure sensor.

In a computer recording medium storing computer-readable instructions according to another embodiment disclosed herein, the instructions may comprise operations of, in response to a touch input of an external object with respect to the display, performing a first operation based on, at least in part, first coordinate data, when the first coordinate data and third coordinate data are received from the first sensor and the third sensor, respectively, and when second coordinate data is not received from the second sensor; performing the first operation based on, at least in part, the second coordinate data, when the second coordinate data and the third coordinate data are received, and when the first coordinate data is not received; and performing the first operation based on, at least in part, the third coordinate data, when the third coordinate data is received, and when the first coordinate data and the second coordinate data are not received.

And each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved. Certain example aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include a ROM, a RAM, compact disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

1. An electronic device comprising:
a housing including a first surface facing a first direction and a second surface facing a second direction opposite to the first direction;
a display disposed between the first and second surfaces of the housing and exposed through the first surface;
a touch sensor disposed between the first surface of the housing and the display or within the display, and configured to sense a position on the display, the touch being performed by an external object;
a pen sensor disposed between the display and the second surface of the housing, and configured to sense a touch position of a stylus pen on the display;
a pressure sensor disposed between the pen sensor and the second surface of the housing, and configured to sense a pressure of the external object on the display;
at least one processor electrically connected to the display, the touch sensor, the pen sensor, and the pressure sensor; and
at least one memory electrically connected to the at least one processor,
wherein the at least one memory stores instructions causing the at least one processor to:
sense a pressure of the external object with respect to the display by using the pressure sensor,
sense a touch position of the external object by using the touch sensor when the external object includes a conductor,
sense the touch position of the external object by using the pen sensor when the external object is a stylus pen configured to be capable of transmitting an electromagnetic signal to the pen sensor,
sense the touch position of the external object by using the pressure sensor in case of failing to sense the external object through the touch sensor and/or the pen sensor, and
perform at least one function, based on, at least in part, the touch position sensed by the touch sensor, the pen sensor, and/or the pressure sensor, and the pressure sensed by the pressure sensor.

2. The electronic device of claim 1, wherein the case of failing to sense the external object through the touch sensor and/or the pen sensor includes at least one of a case where the external object is an insulator incapable of transmitting an electromagnetic signal to the pen sensor, or a case where moisture is contacted to at least a part of the first surface of the housing.

3. The electronic device of claim 1, wherein the at least one memory further stores instructions causing the at least one processor to:
sense the touch position by using the touch sensor, the pen sensor, and/or the pressure sensor, based on a determination that the sensed pressure is greater than a threshold.

4. The electronic device of claim 1, wherein the at least one memory further stores instructions causing the at least one processor to:
change a screen outputted on the display when the touch sensor and/or the pen sensor fail to sense a touch by the external object and when the pressure sensor senses the pressure by the external object for a selected time.

5. The electronic device of claim 4, wherein the at least one memory further stores instructions causing the at least one processor to:
change the screen, based on, at least in part, an arrangement pattern of the pressure sensor.

6. An electronic device comprising:
a housing including a first surface facing a first direction and a second surface facing a second direction opposite to the first direction;
a display disposed between the first and second surfaces of the housing and exposed through the first surface;
a first sensor disposed between the first and second surfaces of the housing, and configured to sense a touch position of an external object with respect to the display at a first resolution and thereby generate first coordinate data;
a second sensor disposed between the first and second surfaces of the housing, and configured to sense the touch position at a second resolution, perform a sensing in a different manner of the first sensor, and thereby generate second coordinate data;
a third sensor disposed between the first and second surfaces of the housing, and configured to sense at a third resolution the touch position and pressure data applied to the display by the external object and thereby generate third coordinate data;
at least one processor electrically connected to the display, the first sensor, the second sensor, and the third sensor; and
at least one memory electrically connected to the at least one processor,
wherein the at least one memory stores instructions causing the at least one processor to:
when the external object is in contact with the display,
perform a first operation based on, at least in part, the first coordinate data, when the first coordinate data and the third coordinate data are received from the first sensor and the third sensor, respectively, and when the second coordinate data is not received from the second sensor,
perform the first operation based on, at least in part, the second coordinate data, when the second coordinate data and the third coordinate data are received from the second sensor and the third sensor, respectively, and when the first coordinate data is not received from the first sensor, and
perform the first operation based on, at least in part, the third coordinate data, when the third coordinate data is received from the third sensor, and when the first coordinate data and the second coordinate data are not received from the first sensor and the second sensor, respectively.

7. The electronic device of claim 6, wherein the at least one processor includes:
an application processor; and
an integrated circuit (IC) electrically coupled between the third sensor and the application processor.

8. The electronic device of claim 7, wherein the integrated circuit is configured to:
receive the pressure data and the third coordinate data from the third sensor,
receive a request for the third coordinate data from the application processor when the application processor fails to receive the first coordinate data and the second coordinate data from the first sensor and the second sensor, respectively, and
transmit the third coordinate data to the application processor in response to the received request.

9. The electronic device of claim 6, wherein the third resolution is smaller than the first resolution and/or the second resolution.

10. The electronic device of claim 6, wherein the first sensor is configured to sense the touch position at the first resolution and thereby generate the first coordinate data when the external object includes a conductor.

11. The electronic device of claim 6, wherein the second sensor is configured to sense the touch position at the second resolution, perform the sensing in a different manner from the first sensor, and thereby generate the second coordinate data when the external object is capable of emitting an electromagnetic signal to an outside.

12. The electronic device of claim 6, wherein the at least one memory further stores instructions causing the at least one processor to:
change a screen outputted on the display when the first sensor and/or the second sensor fail to sense the touch position for a predetermined time and when the third sensor senses the pressure by the external object.

13. The electronic device of claim 12, wherein the at least one memory further stores instructions causing the at least one processor to:
change the screen, based on an arrangement of the third sensor.

14. A method of operating an electronic device including a first sensor, a second sensor, and a third sensor receiving a touch position of an external object with respect to a display at a first resolution, a second resolution, and a third resolution, the method comprising:
sensing a touch of the external object with respect to the display;
performing a first operation based on, at least in part, first coordinate data, when the first coordinate data and third coordinate data are received from the first sensor and the third sensor, respectively, and when second coordinate data is not received from the second sensor;
performing the first operation based on, at least in part, the second coordinate data, when the second coordinate data and the third coordinate data are received, and when the first coordinate data is not received; and
performing the first operation based on, at least in part, the third coordinate data, when the third coordinate data is received, and when the first coordinate data and the second coordinate data are not received.

15. The method of claim 14, further comprising:
changing a screen outputted on the display when the first sensor and/or the second sensor fail to sense a touch by the external object for a predetermined time and when the third sensor senses a pressure by the external object.

16. An electronic device comprising:
a housing including a first surface facing a first direction and a second surface facing a second direction opposite to the first direction;
a display disposed between the first and second surfaces of the housing and exposed through the first surface;
a touch sensor disposed between the first surface of the housing and the display or within the display, and configured to sense a touch position of an external object with respect to the display;
a pen sensor disposed between the display and the second surface of the housing, and configured to sense a touch position of a stylus pen with respect to the display; and
a pressure sensor disposed between the pen sensor and the second surface of the housing, and configured to sense a pressure of the external object with respect to the display.

17. The electronic device of claim 16, wherein the display includes an active area in which a screen is displayed, and an inactive area around the active area, and
wherein at least a portion of the inactive area is folded in the second direction.

18. The electronic device of claim 17, wherein the display further includes a first polymer layer, and a second polymer layer attached to the first polymer layer, and
wherein the second polymer layer has a first portion disposed at least a part of the active area and a second portion disposed at least a part of the folded portion.

19. The electronic device of claim 18, wherein the touch sensor, the pen sensor, and the pressure sensor are disposed, at least in part, between the first and second portions of the second polymer layer.

20. An electronic device comprising:
a display;
a touch sensor configured to sense a touch position corresponding to a touch of an external object on the display;
a pen sensor configured to sense a touch position corresponding to a touch of a stylus pen on the display, based on a change in electromagnetic signals;
a pressure sensor configured to sense a pressure and the touch position corresponding to the touch of the external object or the stylus pen on the display; and
a processor configured to:
determine, based on a sensing result of the pressure sensor, whether the external object or the stylus pen is touched on the display,
determine whether the touch sensor and/or the pen sensor sense the touch position, when a touch on the display is sensed, and determine the touch position by using one of the touch sensor, the pen sensor, and the pressure sensor, based on the sensed result of the touch position by the touch sensor and/or the pen sensor, and
perform at least one function, based on, at least in part, the touch position and the pressure.
